(19) United States
(12) Patent Application Publication
(10) Pub. No.: US 2005/0113271 A1
(43) Pub. Date: May 26, 2005

(54) Automatic dishwashing detergent with improved glass anti-corrosion properties II

(76) Inventors: Ulrich Pegelow, Duesseldorf (DE); Arnd Kessler, Monheim (DE)

Correspondence Address: HENKEL CORPORATION, THE TRIAD, SUITE 200, 2200 RENAISSANCE BLVD., GULPH MILLS, PA, 19406, US

(21) Appl. No.: 11/002,519

(22) Filed: Dec. 2, 2004

Related U.S. Application Data
(63) Continuation of application No. PCT/EP03/05602, filed on May 28, 2003.

(30) Foreign Application Priority Data
Jun. 6, 2002 (DE) 102 25 116.9

(51) Int. Cl. C11D 1/00

(52) U.S. Cl. 510/220; 510/232

(57) ABSTRACT

Dishwasher detergent or dishwasher detergent assistant compositions containing at least one zinc salt and 0.1 to 20% by weight of crystalline sheet-like silicate(s) of the general formula (Ia)
NaMSiₓO₂ₓ₊₁y.H₂O (Ia), in which M is sodium or hydrogen, x is a number from 1.9 to 22, and y is a number from 0 to 33, wherein the zinc salt(s) and the crystalline sheet-like silicate(s) are present in a weight ratio of 3:1 to 1:10.

### CROSS REFERENCE TO RELATED APPLICATIONS

This application is continuation under 35 U.S.C. § 365(c) and 35 U.S.C. § 120 of international application PCT/EP03/05602, filed May 28, 2003. This application also claims priority under 35 U.S.C. § 119 of DE 102 25 116.9, filed Jun. 6, 2002, which is incorporated herein by reference in its entirety.

### BACKGROUND OF THE INVENTION

The present invention is in the field of dishwasher detergents. In particular, the present invention relates to dishwasher detergents which comprise zinc salts and certain silicates.

With the continuing automation of very diverse washing and cleaning processes domestically and in industry, machine washing and cleaning compositions for textiles and dishes have become increasingly important in the past decades.

The so-called low-alkaline detergents required for machine dishwashing often comprise, as alkali carriers, mixtures of sodium disilicate and soda, builders such as citric acid, for example in combination with polycarboxylates, and preferably low-foam, nonionic surfactants. In addition, bleaches, bleach activators, silver protectants and corrosion protectants and, to enhance the detergency, enzymes may be present. In a typical dishwasher cycle, the dishes placed into baskets are cleaned as a result of intensive contact with the aqueous detergent solution at about 65° C. and pH values between 9 and 11 and are then rinsed clear.

An important criterion for assessing a dishwasher detergent is, as well as its detergency, the optical appearance of the dry dishes after washing. Any calcium carbonate deposits which arise on dishes or in the inside of the machine can, for example, adversely affect customer satisfaction and thus have a causal influence on the economic success of such a detergent. A further problem which has been in existence for a long time with machine dishwashing is the corrosion of glassware, which may usually manifest itself in the appearance of clouding, streaking or scratching, or else by iridescence of the glass surface. The observed effects are based essentially on two processes, the escape of alkali metal and alkaline earth metal ions from the glass combined with hydrolysis of the silicate network, and secondly deposition of silicatic compounds on the surface of the glass. To avoid such corrosion processes, the prior art gives a series of proposals, for example with regard to the use of zinc salts.

According to the teaching of the American patent specification U.S. Pat. No. 3,677,820 (Whirlpool Corporation), a zinc strip attached to the inside of the dishwasher prevents the corrosion of glass surfaces during the washing operation.

Finally, European patent application EP 0 383 482 (Procter & Gamble Company) describes dishwasher detergents comprising insoluble zinc salts which are characterized by improved glass corrosion protection. To achieve such an effect, the insoluble zinc salts must have a particle size below 1.7 millimeters.

However, the use of silicates to prevent glass corrosion during machine dishwashing has also been described.

For example, international patent application WO 96/12783 (Henkel KGaA) discloses phosphate-free to low-phosphate dishwasher detergents with improved decoration protection and glass protection based on citrate-containing formulations which comprise crystalline layered silicates.

International patent application WO 99/57237 (Clariant GmbH, Henkel KGaA) provides phosphate-containing dishwasher detergents which comprise a pulverulent to granular additive which have, as essential constituents, a crystalline layered silicate of the general formula NaMSiₓO₂ₓ₊₁.yH₂O, in which M is sodium or hydrogen, x is a number from 1.9 to 22 and y is a number from 0 to 33, and (co)polymeric polycarboxylic acid and, as well as having glass and decoration protective effects, also have excellent detergencies.

The object of the present invention was then to provide a dishwasher detergent which, even upon repeated use, does not corrosively change the surfaces of glassware, in particular does not cause clouding, smearing or scratches, nor iridescence of the glass surfaces. The aim was preferably to provide an additive for a dishwasher detergent which is suitable as a constituent of dishwasher detergents in any supply form, for example as a constituent of powder, tablet or liquid formulations, detergent mousses or donor products, without limiting them in terms of formulation.

It has now been found that the abovementioned objects are achieved by those dishwasher detergents or dishwasher detergent assistants which, besides comprising at least one zinc salt, also comprise at least one crystalline sheet-like silicate. The present application therefore provides dishwasher detergents or dishwasher detergent assistants comprising at least one zinc salt and at least one crystalline sheet-like silicate of the general formula (I)
a A₂O.b BO.c C₂O₃.d D₂O₅.x SiO₂.f H₂O (I),
in which A is an alkali metal and/or hydrogen, B is an alkaline earth metal and/or a subgroup element, preferably an element from the group consisting of zinc, iron, manganese, C is an element of the third main group of the Periodic Table of the Elements and/or a subgroup element, preferably iron, and D is an element of the fifth main group of the Periodic Table of the Elements and/or a subgroup element and the following also applies: 0≦a≦1; 0≦b≦0.5; 0≦c/x≦0.05; 0≦d/x≦0.25; 1.9≦x≦22; 0≦f≦40.

In a preferred embodiment of the present invention, the dishwasher detergent or dishwasher detergent assistant comprises at least one zinc salt and at least one crystalline sheet-like silicate of the general formula (I)

a A₂O.b BO.c C₂O₃.d D₂O₅.x SiO₂.f H₂O (I),

in which A is an alkali metal and/or hydrogen, B is an alkaline earth metal and/or zinc, C is an element of the third main group of the Periodic Table of the Elements and D is an element of the fifth main group of the Periodic Table of the Elements and the following also applies: 0≦a≦1; 0≦b≦0.5; 0≦c/x≦0.05; 0≦d x≦0.25; 1.9≦x≦22; 0≦f≦40.

Finally, it is particularly preferred that the dishwasher detergent or dishwasher detergent assistant comprises at least one zinc salt and at least one crystalline sheet-like silicate of the general formula (I)
a A₂O.b BO.c C₂O₃.d D₂O₅. x SiO₂.f H₂O (I),
in which A is an alkali metal and/or hydrogen, B is an alkaline earth metal, C is an element of the third main group of the Periodic Table of the Elements and D is an element of the fifth main group of the Periodic Table of the Elements and the following also applies: 0≦a≦1; 0≦b≦0.5; 0≦c/x≦0.05; 0≦d/x≦0.25; 1.9≦x≦22; 0≦f≦40.

In particularly preferred compositions according to the invention, the crystalline sheet-like silicate comprises, based on its weight, up to 10 mol %, preferably between 0.01 and 10 mol %, preferably between 0.01 and 8 mol % and in particular between 0.01 and 5 mol %, of boron.

In a further preferred embodiment of the compositions according to the invention, the crystalline sheet-like silicate comprises up to 50 mol %, preferably between 0.01 and 50 mol %, preferably between 0.01 and 40 mol % and in particular between 0.01 and 20 mol %, of phosphorus.

In a further preferred embodiment of compositions according to the invention, the following applies to the formula (I): a=1 and b=c=d=0; A is sodium or sodium or hydrogen. A preferred subject-matter of the present application is therefore dishwasher detergents or dishwasher detergent assistants comprising at least one zinc salt and at least one crystalline sheet-like silicate of the general formula (Ia)
NaMSiₓO₂ₓ₊₁.y H₂O (Ia),
in which M is sodium or hydrogen, x is a number from 1.9 to 22, preferably from 1.9 to 4, and y is a number from 0 to 33.

For the corrosion-inhibiting effect of compositions according to the invention it has proven particularly advantageous if the zinc salt(s) and the crystalline sheet-like silicate(s) of the general formula (I) or of the general formula (Ia) are present in these compositions in the ratio 10:1 to 1:50, preferably from 5:1 to 1:30 and in particular from 3:1 to 1:10.

The crystalline sheet-like silicates of the formula (Ia) are sold, for example, by Clariant GmbH (Germany) under the trade name Na—SKS, e.g. Na—SKS-1 (Na₂Si₂₂O₄₅.xH₂O, kenyaite), Na—SKS-2 (Na₂Si₁₄O₂₉.xH₂O, magadiite), Na—SKS-3 (Na₂Si₈O₁₇.xH₂O) or Na—SKS-4 (Na₂Si₄O₉.xH₂O, makatite).

Compositions which are particularly suitable for the purposes of the present invention are those which comprise crystalline sheet silicates of the formula (Ia) in which x is 2. Of these, Na—SKS-5 (α-Na₂Si₂O₅), Na—SKS-7 (β-Na₂Si₂O₅, natrosilite), Na—SKS-9 (NaHSi₂O₅.H₂O) Na—SKS-10 (NaHSi₂O₅.3H₂O, kanemite), Na—SKS-11 (t-Na₂Si₂O₅) and Na—SKS-13 (NaHSi₂O₅), in particular are suitable, but especially Na—SKS-6 (δ-Na₂Si₂O₅). An overview of crystalline sheet silicates is given, for example, in the article published in Seifen-Öle-Fette-Wachse, volume 116, No. 20/1990 on pages 805-808.

Within the scope of the present application, preferred dishwasher detergents or dishwasher detergent assistants have a weight fraction of the crystalline sheet-like silicate of the general formula (I) or of the general formula (Ia) of from 0.1 to 20% by weight, preferably from 0.2 to 15% by weight and in particular from 0.4 to 10% by weight, in each case based on the total weight of these compositions.

Besides the specified crystalline sheet-like silicates, compositions according to the invention comprise zinc salts, it being preferred to use both inorganic and also organic salts. A nonexhaustive list of some preferred zinc salts is given in the table below:

| Zinc salt | Solubility |
|---|---|
| Zinc acetate dihydrate | 430 g/l (20° C.) |
| Zinc acetylacetonate | 4 g/l (20° C.) |
| Zinc bromide | 820 g/l (25° C.) |
| Zinc chloride | 4320 g/l (25° C.) |
| Zinc gluconate | 100 g/l (20° C.) |
| Zinc hydroxycarbonate | Virtually insoluble (20° C.) |
| Zinc iodide | 4500 g/l (20° C.) |
| Zinc nitrate hexahydrate | 1843 g/l (20° C.) |
| Zinc nitrate tetrahydrate | Readily soluble (20° C.) |
| Zinc oxide | Insoluble |
| Zinc stearate | 0.9 mg/l (20° C.) |
| Zinc sulfate heptahydrate | 960 g/l (20° C.) |
| Zinc sulfate monohydrate | ˜350 g/l (20° C.) |

Besides the insoluble inorganic zinc salts, i.e. salts which have a solubility below 100 mg/l (20° C.), preferably below 10 mg/l (20° C.), in particular no solubility (20° C.) (Ex.: zinc oxide), within the scope of the present application the soluble inorganic zinc salts, i.e. salts which have a solubility in water above 100 mg/l, preferably above 500 mg/l, particularly preferably above 1 g/l and in particular above 5 g/l, are a preferred constituent of compositions according to the invention. Preferred soluble inorganic salts include zinc bromide, zinc chloride, zinc iodide, zinc nitrate and zinc sulfate. The present application therefore further preferably provides dishwasher detergents or dishwasher detergent assistants which comprise at least one zinc salt chosen from the group of inorganic zinc salts, preferably from the group of soluble inorganic zinc salts, in particular from the group consisting of zinc bromide, zinc chloride, zinc iodide, zinc nitrate and zinc sulfate.

The spectrum of the zinc salts, preferred according to the invention, of organic acids, preferably of organic carboxylic acids, ranges from salts which are insoluble in water, i.e. have a solubility below 100 mg/l, preferably below 10 mg/l, in particular no solubility, to those salts which have a solubility in water above 100 mg/l, preferably above 500 mg/l, particularly preferably above 1 g/l and in particular above 5 g/l (all solubilities at 20° C. water temperature). The first group of zinc salts includes, for example, zinc citrate, zinc laurate, zinc oleate, zinc oxalate, zinc tartrate and zinc stearate, and the group of soluble organic zinc salts includes, for example, zinc acetate, zinc acetylacetonate, zinc benzoate, zinc formate, zinc lactate and zinc gluconate, zinc valerate and the zinc salt of p-toluenesulfonic acid.

In a further preferred embodiment, dishwasher detergents or dishwasher detergent assistants according to the invention therefore comprise at least one zinc salt chosen from the group of organic zinc salts, preferably from the group of soluble organic zinc salts, particularly preferably from the group of soluble zinc salts of monomeric or polymeric organic acids, in particular from the group consisting of zinc acetate, zinc acetylacetonate, zinc benzoate, zinc formate, zinc lactate, zinc gluconate, zinc ricinoleate, zinc abietate, zinc valerate and zinc p-toluenesulfonate.

Preferred compositions according to the invention can of course also comprise mixtures of organic and inorganic zinc salts, in particular mixtures of soluble organic zinc salts with insoluble inorganic zinc salts or mixtures of soluble organic zinc salts with soluble inorganic zinc salts or mixtures of insoluble organic zinc salts with insoluble inorganic zinc salts or mixtures of insoluble organic zinc salts with soluble inorganic zinc salts.

Within the scope of the present application, preference is given to dishwasher detergents or dishwasher detergent assistants in which the weight fraction of the zinc salt, based on the total weight of this composition, is 0.1 to 10% by weight, preferably 0.2 to 7% by weight and in particular 0.4 to 4% by weight, irrespective of which zinc salts are used, thus in particular irrespective of whether organic or inorganic zinc salts, soluble or insoluble zinc salts or mixtures thereof are used.

Compositions according to the invention are not subject to any limitation with regard to their formulation and supply forms. Dishwasher detergents or dishwasher detergent assistants within the scope of the present invention may therefore be provided either in solid form or else in liquid form.

Depending on the field of use of the process according to the invention, it may be necessary or desired to release different or identical active substances and/or active substance preparations present in the compositions according to the invention in a temporally controlled manner. This temporally controlled release can take place by various mechanisms or, in other words, on the basis of different “switches”. Based on the zinc salts and sheet-like silicates present in the compositions according to the invention, this means that these active substances are preferably released together, but temporally displaced compared with one or more further active substances and/or active substance preparations, such as, for example, builder substances (builders, cobuilders), surfactants, bleaches, bleach activators, enzymes, dyes, fragrances, corrosion protectants or polymers. Here, the zinc salt and/or the sheet silicate can be released into the aqueous liquor either before or after these active substances have been released.

Possible “switches” which influence the release behavior of active substances or active substance preparations are, for example,
the state of aggregation and the formulation form of the compositions; liquid compositions often dissolve more quickly than solid compositions; solid compositions with a large surface area (e.g. powders, granules) dissolve more quickly than solid compositions with a comparatively smaller surface area (e.g. tablets);
the mechanical stability which—depending on the time, on the temperature or on other parameters—may be a factor determining the disintegration;
the temperature, i.e. the attainment of a certain temperature value in the course of the temperature profile of the washing, cleaning or rinsing operation; control via the temperature represents a reliable and thus preferred embodiment particularly in the case of dishwashing detergents due to the temperature which increases with every stage of the rinsing operation;
the pH, i.e. the establishment of a certain pH in the course of a washing, cleaning or rinsing operation by components of the washing-active, cleaning-active or rinse-active preparation or the leaving of a certain pH following disintegration of a component which determines or influences the pH;
the ionic strength;
the presence of enzymes
the use of preferably water-soluble packaging materials, and their permeability for a certain—primarily gaseous or liquid—component; etc.

The abovementioned parameters are only examples which are not intended to limit the invention.

If the compositions according to the invention are prepared, for example, as combination products from two or more substances or substance mixtures in varying formulation form/state of aggregation, then the composition according to the invention which comprises the zinc salt and the sheet silicate is preferably present in only one of these compositions. Varying formulation forms/states of aggregation in the present application are, for example, liquids, powders, granules, compacts, extrudates, moldings, gels, dispersions. Such varying compositions can be formulated to give a combination product, for example, by means of a common, preferably water-soluble packaging which has one, two, three, four or more receiving chambers. Methods for producing such packagings are known to the person skilled in the art. These methods include, for example, deep-drawing, extrusion or molding methods. In the text below, by reference to single-chamber and twin-chamber packagings, a number of combinations of differently formulated compositions that are preferred according to the invention are described:

Water-soluble or water-dispersible packaging with one receiving chamber:

Receiving chamber 1

Composition according to the invention in a powder and
liquid
Composition according to the invention in a powder and
further powder
Composition according to the invention in a powder and
granules
Composition according to the invention in a powder and
compact
Composition according to the invention in a powder and
extrudate
Composition according to the invention in a powder and
molding
Composition according to the invention in a powder and
dimensionally stable gel
Composition according to the invention in a melt and
liquid
Composition according to the invention in a melt and
further powder
Composition according to the invention in a melt and
granules
Composition according to the invention in a melt and
compact
Composition according to the invention in a melt and
extrudate
Composition according to the invention in a melt and
molding
Composition according to the invention in a melt and
dimensionally stable gel
Composition according to the invention in granules and
liquid
Composition according to the invention in granules and
further powder
Composition according to the invention in granules and
granules
Composition according to the invention in granules and
compact
Composition according to the invention in granules and
extrudate
Composition according to the invention in granules and
molding
Composition according to the invention in granules and
dimensionally stable gel

Water-soluble or water-dispersible packaging with two receiving chambers:

| Receiving chamber 1 | Receiving chamber 2 |
|---|---|
| Composition according to the | Liquid |
| invention in a dispersion | |
| Composition according to the | Powder |
| invention in a dispersion | |
| Composition according to the | Granules |
| invention in a dispersion | |
| Composition according to the | Compact |
| invention in a dispersion | |
| Composition according to the | Extrudate |
| invention in a dispersion | |
| Composition according to the | Molding |
| invention in a dispersion | |
| Composition according to the | Dimensionally |
| invention in a dispersion | stable gel |
| Composition according to the | Dispersion |
| invention in a dispersion | |
| Composition according to the | Liquid |
| invention in a powder | |
| Composition according to the | Powder |
| invention in a powder | |
| Composition according to the | Granules |
| invention in a powder | |
| Composition according to the | Compact |
| invention in a powder | |
| Composition according to the | Extrudate |
| invention in a powder | |
| Composition according to the | Molding |
| invention in a powder | |
| Composition according to the | Dimensionally |
| invention in a powder | stable gel |
| Composition according to the | Dispersion |
| invention in a powder | |
| Composition according to the | Liquid |
| invention in granules | |
| Composition according to the | Powder |
| invention in granules | |
| Composition according to the | Granules |
| invention in granules | |
| Composition according to the | Compact |
| invention in granules | |
| Composition according to the | Extrudate |
| invention in granules | |
| Composition according to the | Molding |
| invention in granules | |
| Composition according to the | Dimensionally |
| invention in granules | stable gel |
| Composition according to the | Dispersion |
| invention in granules | |
| Composition according to the | Liquid |
| invention in a compact | |
| Composition according to the | Powder |
| invention in a compact | |
| Composition according to the | Granules |
| invention in a compact | |
| Composition according to the | Compact |
| invention in a compact | |
| Composition according to the | Extrudate |
| invention in a compact | |
| Composition according to the | Molding |
| invention in a compact | |
| Composition according to the | Dimensionally |
| invention in a compact | stable gel |
| Composition according to the | Dispersion |
| invention in a compact | |
| Composition according to the | Liquid |
| invention in an extrudate | |
| Composition according to the | Powder |
| invention in an extrudate | |
| Composition according to the | Granules |
| invention in an extrudate | |
| Composition according to the | Compact |
| invention in an extrudate | |
| Composition according to the | Extrudate |
| invention in an extrudate | |
| Composition according to the | Molding |
| invention in an extrudate | |
| Composition according to the | Dimensionally |
| invention in an extrudate | stable gel |
| Composition according to the | Dispersion |
| invention in an extrudate | |
| Composition according to the | Liquid |
| invention in a molding | |
| Composition according to the | Powder |
| invention in a molding | |
| Composition according to the | Granules |
| invention in a molding | |
| Composition according to the | Compact |
| invention in a molding | |
| Composition according to the | Extrudate |
| invention in a molding | |
| Composition according to the | Molding |
| invention in a molding | |
| Composition according to the | Dimensionally |
| invention in a molding | stable gel |
| Composition according to the | Dispersion |
| invention in a molding | |

For the production of the water-soluble and/or water-dispersible film, in principle all substances or substance mixtures which can be formulated in the form of a film are suitable. However, particular preference is given to a method in which the water-soluble and/or water-dispersible film consists of (acetalized) polyvinyl alcohol, polyvinylpyrrolidone, polyethylene oxide, gelatin, starch and starch derivative(s), cellulose and cellulose derivative(s), in particular methylcellulose and/or mixtures of these substances, this list to be regarded as being exemplary and nonlimiting for the invention.

In a further, likewise preferred embodiment, it is advantageous according to the invention if the film(s) comprises/comprise one or more materials from the group of acrylic acid-containing polymers, polyacrylamides, oxazoline polymers, polystyrenesulfonates, polyurethanes, polyesters and polyethers and mixtures thereof.

With particular advantage one or more material(s) from the following exemplary, but nonlimiting list may be specified:
mixtures of 50 to 100% polyvinyl alcohol or poly(vinyl alcohol-co-vinyl acetate) with molecular weights in the range from 10 000 to 200 000 g/mol and acetate contents of from 0 to 30 mol %; these may comprise processing additives such as plasticizers (glycerol, sorbitol, water, PEG, etc.), lubricants (stearic acid and other mono-, di- and tricarboxylic acids), so-called slip agents (e.g. “Aerosil”), organic and inorganic pigments, salts, blow-molding agents (citric acid/sodium bicarbonate mixtures);
acrylic acid-containing polymers, such as, for example, copolymers, terpolymers or tetrapolymers which comprise at least 20% acrylic acid and have a molecular weight of from 5000 to 500 000 g/mol; as comonomers, particular preference is given to acrylic esters, such as ethyl acrylate, methyl acrylate, hydroxyethyl acrylate, ethylhexyl acrylate, butyl acrylate, and salts of acrylic acid, such as sodium acrylate, methacrylic acid and salts thereof and esters thereof, such as methyl methacrylate, ethyl methacrylate, trimethylammonium methyl methacrylate chloride (TMAEMC), methacrylateamidopropyltrimethylammonium chloride (MAPTAC). Further monomers, such as acrylamide, styrene, vinyl acetate, maleic anhydride, vinylpyrrolidone, can likewise be used advantageously;
polyalkylene oxides, preferably polyethylene oxides with molecular weights of from 600 to 100 000 g/mol and derivatives thereof modified by graft copolymerization with monomers such as vinyl acetate, acrylic acid and salts thereof and esters thereof, methacrylic acid and salts thereof and esters thereof, acrylamide, styrene, styrenesulfonate and vinylpyrrolidone (for example: polyethylene glycol-graft-vinyl acetate). The polyglycol fraction should be 5 to 100% by weight, the graft fraction should be 0 to 95% by weight; the latter can consist of one or more monomers. Particular preference is given to a graft fraction of from 5 to 70% by weight; here, the solubility in water decreases with the graft fraction;
polyvinylpyrrolidone (PVP) with a molecular weight of from 2500 to 750 000 g/mol;
polyacrylamide with a molecular weight of from 5000 to 5 000 000 g/mol;
polyethyloxazoline and polymethyloxazoline with a molecular weight of from 5000 to 100 000 g/mol;
polystyrenesulfonates and copolymers thereof with comonomers such as ethyl (meth)acrylate, methyl (meth)acrylate, hydroxyethyl (meth)acrylate, ethylhexyl (meth)acrylate, butyl (meth)acrylate and the salts of (meth)acrylic acid, such as sodium (meth)acrylate, acrylamide, styrene, vinyl acetate, maleic anhydride, vinylpyrrolidone; the comonomer content should be 0 to 80 mol %, and the molecular weight should be in the range from 5000 to 500 000 g/mol;
polyurethanes, in particular the reaction products of diisocyanates (e.g. TMXDI) with polyalkylene glycols, in particular polyethylene glycols of molecular weight 200 to 35 000, or with other difunctional alcohols to give products with molecular weights of from 2000 to 100 000 g/mol;
polyesters with molecular weights of from 4000 to 100 000 g/mol, based on dicarboxylic acids (e.g. terephthalic acid, isophthalic acid, phthalic acid, sulfoisophthalic acid, oxalic acid, succinic acid, sulfosuccinic acid, glutaric acid, adipic acid, sebacic acid, etc.) and diols (e.g. polyethylene glycols, for example with molecular weights of from 200 to 35 000 g/mol);
cellulose ethers/esters, e.g. cellulose acetates, cellulose butyrates, methylcellulose, hydroxypropylcellulose, hydroxyethylcellulose, methyl-hydroxypropylcellulose, etc.;
polyvinyl methyl ethers with molecular weights of from 5000 to 500 000 g/mol.

Embodiments of the water-soluble films that are particularly preferred according to the invention also take into consideration the fact that with particular advantage—but not necessarily—the active substances and/or active substance preparations present in the receiving depressions can be fed into the aqueous liquor through a—preferably controllable—solubility in water of the film material at a certain point in time during the washing, cleaning or rinsing operation, for example upon reaching a certain temperature, or upon reaching a certain pH or a certain ionic strength of the wash liquor or else due to other controllable events or conditions.

The quality of the material and also its quantity/thickness have a direct influence on these solubility properties. Within the scope of the present invention, particular preference is therefore given to a process which is characterized in that the thickness of the water-soluble film is between 1 μm and 1000 μm, preferably between 5 μm and 500 μm and in particular between 10 μm and 200 μm. Various film thicknesses with the aim of delaying the release of active substances and/or active substance preparations can be realized, for example, also advantageously through the multiple sealing of one or more receiving chambers by means of one or more identical or different water-soluble films. The thickness of the water-soluble film for the purposes of the present invention is then given as the sum of the thicknesses of the superimposed water-soluble individual films sealing a receiving depression.

Particular preference is given to materials for the water-soluble films which dissolve—based on a certain thickness codetermining the stability—at certain temperatures, pH values, ionic strengths, or after a certain residence time in the aqueous liquor. In this connection, such a dissolution operation can seize the film as a whole or only a section of it, meaning that sections of the film dissolve as a particular parameter combination is established, whereas other sections do not yet dissolve (but only later), if at all. The latter can be achieved by varying the quality of the material and also by varying the amounts of material (thickness) or else varying geometries of the water-insoluble container. For example, it is possible, by virtue of the external shape of the water-insoluble container, to hinder the ingress of water and thus to delay the dissolution operation. In another preferred embodiment, it is possible to configure the films in various thicknesses (although made of the same material) and thus to permit earlier dissolution at the thinner areas. If water-soluble films of such varying thicknesses are used to cover different receiving depressions, the active substances located in these receiving depressions are released at different times. In a further likewise preferred embodiment, the films can be produced from materials of varying solubility in water, for example from polyvinyl alcohols (PVAL) with varying residual acetate content.

In a particularly preferred embodiment, besides the specified ingredients, the water-soluble and/or water-dispersible film can also comprise one or more washing- or cleaning-active substances or consist of these substances (Ex.: polyvinyl alcohols as film material and builder). In the first-mentioned case, washing-active, cleaning-active and rinse-active ingredients, which are only present in the preparations in small amounts and whose uniform incorporation is therefore not unproblematical, can, for example, be incorporated into the film or a section of the film, for example one which dissolves precisely at the wash-cycle, cleaning-cycle, rinse-cycle stage where the active ingredient is required, as a result of which it is released into the liquor as the film dissolves at the correct time. One example of this may be fragrances which are desired in the last phase of the washing or cleaning or rinsing operation, but also optical brighteners, UV protectants, dyes and other washing-active, cleaning-active or rinse-active preparations.

A further likewise preferred embodiment of compositions according to the invention within the scope of the present application is the temporally controlled release of one or more of the active substance(s) and/or active substance preparation(s) present in these compositions through the incorporation of matrix or coating materials of varying solubility or melting temperature.

According to that stated above, differences in the release rate of active substances and/or active substance mixtures can be achieved through the use of matrix materials or coatings which have different melting temperatures. Particular preference here is given to the use of meltable or softenable substances as matrix or coating material for the active substances or active substance preparations. (Within the scope of the present invention, the term “coating” includes, besides the coating of individual or a plurality of sides or surfaces of an object, such as, for example, a solid particulate composition, also the complete coating, i.e. the enveloping of this particulate object. The sealing of a receiving depression by a meltable substance by pouring such a substance onto a particulate or gel-like active substance/active substance preparation is also referred to as coating. The term “active substances” or “active substance preparations” covers both the zinc salts/sheet silicates characteristic of the compositions according to the invention and also all other optionally present ingredients.) Meltable substances preferred according to the invention here have a melting point above 30° C. If active substance preparations are to be released at different times, for example during the different wash cycles of a cleaning process, then this may take place, for example, through the use of different meltable matrices or coatings. If two or more different meltable matrices are used, then the melting points are preferably matched to the temperature course of this cleaning process, the difference in the melting points sufficing to ensure the separate dissolution of the individual matrices or coatings. In this connection, preference is given to those substances for the different matrices and/or coatings which differ with regard to their melting point by at least 5° C., preferably by 10° C., particularly preferably by 15° C. and especially by at least 20° C., it also being preferred that the melting point of at least one of the meltable substances which form a matrix or a coating is less than 30° C., while the melting point of at least one other substance which forms a further matrix or coating is above 30° C.

If it is the intention to use a softenable substance as matrix for an active substance or an active substance preparation, then this mass, which is softenable under the effect of temperature, can be formulated by mixing the desired further ingredients with this meltable or softenable substance and heating the mixture to temperatures in the softening range of this substance and shaping it at these temperatures. If the softenable substances are used as under, then such a coating can take place, for example, by immersion, spraying or circulation in a drum coater or coating pan. Particular preference is given to using waxes, paraffins, polyalkylene glycols, etc. as meltable or softenable substances for the matrices or the coatings.

It has proven advantageous if the meltable or softenable substances do not have a sharply defined melting point, as customarily arises with pure, crystalline substances, but have a melting range possibly covering several degrees Celsius. The meltable or softenable substances preferably have a melting range which is between about 35° C. and about 75° C. In the present case, this means that the melting range occurs within the given temperature interval and does not indicate the width of the melting range. The width of the melting range is preferably at least 1° C., preferably about 2 to about 3° C.

The abovementioned properties are satisfied except by paraffins and polyethylene glycols as a rule also by so-called waxes. More precise descriptions of these groups of substances are given below in the description. In order to avoid repetition, reference is made to these statements at this point.

A further preferred option for the time-delayed release of active substances or active substance preparations is the staggered spatial arrangement of these substances in the receiving chamber of a preferably water-soluble packaging or within a molding or pressed body (onion model) with the aim of a time-staggered release. Such a spatially staggered arrangement is, for example, the layer- or phase-wise arrangement of the active substances or active substance preparations for which, for example, the layer-wise tableting or the layer-wise molding of liquid active substances or active substance mixtures and their subsequent consolidation by solidification and/or crystallization are suitable. Since an ingress of the solvent in the case of compressed or molded shaped bodies can only take place via their surface, this layer-wise arrangement leads to the release of those active substances or active substance mixtures which are located at the surface of such a multiphase mixture. The phases are consequently eroded in a time-displaced manner, the ingredients of which are released in a time-displaced manner.

The above-described methods for the time-controlled release of active substances and/or active substance mixtures are of course not an end in itself, but serve for the targeted control of the cleaning process.

For example, a program for machine dishwashing generally includes various wash cycles, where the type and number of these wash cycles can be determined by the consumer by means of a choice of program. Examples of such cleaning cycles are the prewash cycle, intermediate wash and main wash cycles or the rinse cycle. For an optimum result, all of these various wash cycles require the targeted dosing of corresponding active substances or active substance mixtures. In particular, to optimize the active ingredient combination of zinc salts with sheet silicates used according to the invention, a controlled premature or delayed release of zinc salts and/or sheet silicates and/or further active substances may be required here, depending on the nature of the further active substances used.

Solid supply forms of the dishwasher detergent or dishwasher detergent assistants according to the invention are, for example, finely to coarsely granular powders as are obtained, for example, by spray-drying or granulation, compacted substance mixtures from roll compaction, but also solidified melts or moldings obtained by extrusion or tableting. Within the scope of the present invention, such moldings have virtually all configurations which can be usefully handled, such as, for example, in the shape of a slab, in rod or bar form, a cube, a cuboid and corresponding spatial element with even side surfaces, and in particular cylindrical configurations with circular or oval cross section. This last configuration includes the presentation form of the actual tablet to compact cylinder sections with a height to diameter ratio above 1. Preferred tableted or extruded compositions within the scope of the present invention have two or more phases which can differ, for example, by virtue of their composition, their fraction of the total volume of the molding and/or their optical appearance.

The phases of such multiphase moldings may additionally be characterized by a different dissolution behavior in aqueous phase. Such moldings are suitable for the time-controlled release of certain ingredients (controlled release), for example in certain wash cycles of the dishwasher program. In a preferred embodiment, one of the phases of the molding has, as the main constituent, meltable or softenable substances from the group of waxes, paraffins and/or polyalkylene glycols. Furthermore, it has proven advantageous if the molding or molding constituent comprising these meltable or softenable substances is at least largely insoluble in water. The solubility in water should not exceed about 10 mg/l at a temperature of about 30° C. and should preferably be less 5 mg/l. In such cases the meltable or softenable substances should, however, have the lowest possible solubility in water, including in water at elevated temperature, in order to avoid as far as possible a temperature-dependent release of the active substances. The release of the active substance takes place in this way when the melting or softening point is reached. A further preferred procedure for obtaining controlled release of ingredients, in particular of the combination according to the invention of zinc salt and sheet silicate, from multiphase tablets is the compaction of two or more individual phases with different pressures. Since the disintegration and dissolution properties of tablets or tablet phases are, as is known, dependent inter alia also on the compaction pressure exerted on the tablet phase during tableting, it is possible to produce tablet phases with different disintegration and dissolution properties merely through the use of different compaction pressures. In this connection, it may be preferred according to the invention that the combination according to the invention of zinc salt and sheet silicate are located together in the phase which was subjected to the comparatively higher tableting pressure and therefore disintegrates later. It may, however, depending on the composition of the cleaning composition, also be advantageous to formulate zinc salt and sheet silicate together in the tablet phase which has been tableted using the comparatively lower pressure. Finally, it is also preferred to formulate zinc salt and sheet silicate in different tablet phases, where the zinc salt is present, in one advantageous embodiment, in the comparatively greatly compacted tablet phase while, in another preferred embodiment, it is located in the comparatively lesser compacted tablet phase.

Within the scope of the present application, dishwasher detergent assistants is the term used for those agents which are additionally added to a standard commercial detergent, for example in the form of a special glass protectant. Such a metering can take place either before the start of each wash program or else in the form of a depot product which brings about a continuous release of the composition according to the invention.

Preferred solid compositions according to the invention are in the form of a dosing unit sufficient for one wash cycle. One example of such formulation forms are dishwashing assistant tablets.

If the compositions according to the invention are in solid particulate form, but not in the form of divided dosing units, then for these compositions the problem of individual constituents separating arises, it being necessary in particular to avoid the separation of the zinc salts and silicates present in the compositions according to the invention. Examples of such particulate supply forms are powders or granules. In a preferred embodiment of the present invention, the zinc salt(s) present in the dishwasher detergents or dishwasher detergent assistants and/or the crystalline sheet-like silicate'(s) present is/are formulated with one or more further active and/or builder substance(s), in particulate form, as compound.

Since the zinc salts and crystalline sheet-like silicates only constitute a small weight fraction of preferred dishwasher detergents, a compounding based on their “dilution effect” simplifies the metering of these salts in the manufacture of dishwasher detergents according to the invention. However, even in the case where a composition according to the invention in the form of a special product for glass corrosion protection is only added to a standard commercial detergent by the consumer, the dosing is made easier as a result of the compounding. The advantages of compounding arise entirely independently of whether the dishwasher detergent to which the corresponding compounds are added is solid, liquid or in the form of a gel.

Preferred solid supply forms of the dishwasher detergent according to the invention comprise, for example, finely to coarsely granular powders, as are obtained, for example, by spray-drying or granulation. Powders of this type can be marketed as a commercial product or be used as a premix for the compaction, for example for the tableting and generally have a particle size in the range from 0.1 to 10 mm. In order to prevent this powder separating from the added silicate and/or zinc salt compounds, it is preferred for these compounds to have a particle size comparable with that of the powders.

The present application thus preferably provides a dishwasher detergent, characterized in that the particle size of the zinc salts and/or crystalline sheet-like silicates formulated with one or more active and/or builder substances is between 0.1 and 10 mm, preferably between 0.2 and 8 mm and in particular between 0.5 and 5 mm, with preferred particulate compounds additionally having a density of from 0.1 to 2.0 g/cm³, preferably from 0.2 to 1.6 g/cm³ and in particular from 0.4 to 1.2 g/cm³, to prevent separation processes.

Dishwasher detergents preferred according to the invention are characterized, in particular, in that the particles of the zinc salts and/or crystalline sheet-like silicates formulated with one or more active and/or builder substances have a weight fraction of the zinc salts or crystalline sheet-like silicates of from 0.1 to 80% by weight, particularly preferably from 0.2 to 70% by weight and especially preferably from 0.5 to 60% by weight, in each case based on the total weight of the particles.

The abovementioned particulate compounds are obtained, according to the invention preferably by spray-drying and/or granulation and/or extrusion and/or roll compaction and/or tableting and/or solidification and/or crystallization, but in particular by spray-drying and/or granulation.

During spray-drying, in a first step of the process, an aqueous slurry is prepared which, besides the zinc salts according to the invention, may comprise further thermally stable active and/or filter substances which neither volatilize nor decompose under the conditions of spray-drying, and this slurry is then conveyed to the spray tower by means of pumps and sprayed via nozzles located in the top of the tower. Rising hot air dries the slurry and evaporates the adhering water, meaning that the detergent constituents are obtained as fine powders at the tower outlet. Further temperature-labile constituents, such as, for example, bleaches or fragrances, may be added to these, as required.

Apart from the spray-drying described above, the formulation of compositions according to the invention can also take place by a granulation process, particular preference being given to a fluidized-bed process in which finely particulate bed material which, besides the zinc salts according to the invention, can comprise further active and/or builder substances, lying on horizontal, perforated bases is passed through from below by gases (e.g. hot air). Under certain flow conditions, a state is established which mimics that of a boiling liquid; the layer throws up bubbles, and the particles of the bed material are located within the layer in a constant, swirling to and fro motion and thus remain in suspended form to a certain extent. The large surface area of the swirling material then permits, for example, the reaction with further substances, such as solvents, solutions of active and/or builder substances, liquid active substances, but also further ingredients which are in the form of a solid at room temperature, but soften at least on the surface by increasing the temperature and/or adding very limited amounts of liquid additives and/or form a stickiness and adhesiveness under the influence of temperature. Typical examples of the abovementioned substances are water, and aqueous solutions, it being possible, for example, to also use aqueous solutions of the zinc salts according to the invention, surfactant compounds which are liquid or solid at room temperature, in particular nonionic surfactants, or else polymer compounds of synthetic and/or natural origin, for example (co) polymeric carboxylates.

A further procedure preferred for the granulation is the use of mixers/compacters, as are provided for this purpose by Lödige as well as by other suppliers and which are suitable in a particular manner for the production of particles formulated according to the invention since they offer the consumer, as the result of varying different process parameters, such as rotary speed of the mixer, the residence time of the individual components, the metering time of individual components during the mixing operation, the geometry of the mixing elements used or the energy input, the possibility of targeted control of the product properties of the resulting granulates. The particle size and/or density of granulates can also be influenced in a targeted manner in this way, and the formulation of zinc salts according to the invention with one or more further active and/or builder substance(s) in the abovementioned mixers/compacters is therefore particularly preferred within the scope of the present invention.

Finally, there is the possibility of mixing the zinc salts and/or silicates according to the invention mentioned above with further individual components which differ with respect to their bulk densities only slightly from those of said salts. Such mixtures have only slight separation tendencies of the components upon storage, transportation and processing and are therefore likewise suitable in a particular manner for the desired safe and reliable metering of the silicates and/or zinc salts according to the invention. Within the scope of the present invention, preference is therefore given to mixtures of silicates and/or zinc salts with further active and/or builder substances, characterized in that the bulk density of the individual components mixed with one another differ by at most 200 g/l, preferably by at most 150 g/l, preferably by at most 100 g/l and in particular by at most 50 g/l.

The builder and/or active substances which can be used in the above-described formulation of preferred dishwasher detergents according to the invention include, besides other customary constituents of detergents, for example builders (inc. cobuilders), surfactants, bleaches, bleach activators, enzymes, dyes, fragrances, corrosion protectants or polymers.

Whereas all said substances are in general suitable as active and/or builder substances for the formulation of zinc salts according to the invention, within the scope of the present invention, however, particular preference is given to those dishwasher detergents or dishwasher detergent assistants in which the zinc salt compounds formulated with one or more active and/or builder substances comprise active and/or builder substances from the group of phosphates, carbonates, hydrogencarbonates, sulfates, silicates, citrates, citric acid, acetates,.preferably in amounts of from 20 to 99% by weight, particularly preferably from 30 to 98% by weight and especially preferably from 40 to 95% by weight, in each case based on the total weight of the particles.

Further particularly preferred active and/or builder substances for the formulation of zinc salts within the scope of the present invention are the surfactants, preferably the nonionic surfactants, and/or the polymeric carboxylates, in particular the polysulfocarboxylates.

For a further description of particularly preferred surfactants or polymeric carboxylates and of polysulfocarboxylates, reference may be made again to the following statements in order to avoid repetitions.

The silicates present in the dishwasher detergents or dishwasher detergent assistants according to the invention are also present in these compositions preferably formulated with other active or builder substances, use being made here in particular of active or builder substances from the group of organic mono- or polycarboxylic acids, hydroxypolycarboxylic acids and phosphonic acids.

The present application therefore further preferably provides dishwasher detergents or dishwasher detergent assistants characterized in that the crystalline sheet-like silicate(s) of the general formula (I) or of the general formula (Ia) is/are present formulated with one or more further active and/or builder substance(s), preferably with one or more further active and/or builder substances from the group of organic mono- or polycarboxylic acids, hydroxypolycarboxylic acids and phosphonic acids, in particulate form, as compound.

The zinc salts and/or crystalline sheet-like silicates formulated with one or more active and/or builder substances and present in the form of particles may be provided with a coating for protection from environmental influences and thus for improving their storage stability or for influencing the dissolution behavior. Coating materials and processes for coating particulate compositions are widely described in the literature and will be described below only with respect to particularly preferred embodiments.

Particular preference is given to the use of meltable or softenable substances as coating material. (The term “coating” within the scope of the present invention means, as well as the coating of individual or two or more sides or surfaces of a particulate composition formulated according to the invention, also a complete coating, i.e. the enclosure of a particulate object.) Meltable substances which are preferred according to the invention have a melting point above 30° C. If the formulated zinc salts and/or crystalline sheet-like silicates are to be released at different times, for example during the different wash cycles of a cleaning process, then this may take place, for example, through the use of different meltable coatings which differ with respect to their melting point, the melting points of these substances preferably being matched to the temperature course of this cleaning process and the difference in the melting points sufficing to ensure separate dissolution of the individual matrices or coatings. If, for example, it is intended to release zinc salts and crystalline sheet-lime silicates at different times, then preference is given to those substances for the different coatings which differ with regard to their melting point by at least 5° C., preferably by 10° C., particularly preferably by 15° C. and especially by at least 20° C., it also being preferred that the melting point of at least one of the meltable substances which form a coating is less than 30° C., while the melting point of at least one other substance which forms a further matrix or coating is above 30° C.

Such coatings can be applied, for example, by immersion, spraying or circulation in a drum coater or coating pan. For the coatings, particular preference is given to using waxes, paraffins, polyalkylene glycols etc. as meltable or softenable substances.

It has proven advantageous if the meltable or softenable substances do not exhibit a sharply defined melting point, as usually occurs in the case of pure, crystalline substances, but instead have a melting range which covers, under certain circumstances, several degrees Celsius. The meltable or softenable substances preferably have a melting range between about 45° C. and about 75° C. In the present case, this means that the melting range is within the given temperature interval, and does not define the width of the melting range. The width of the melting range is preferably at least 1° C., preferably about 2 to about 3° C.

The abovementioned properties are usually satisfied by so-called waxes. “Waxes” is understood as meaning a series of natural or artificially obtained substances which generally melt above 40° C. without decomposition, and are of relatively low-viscosity and are non-stringing at just a little above the melting point.

They have a highly temperature-dependent consistency and solubility.

Depending on their origin, the waxes are divided into three groups: the natural waxes, chemically modified waxes and the synthetic waxes.

Natural waxes include, for example, plant waxes, such as candelilla wax, carnauba wax, Japan wax, asparto grass wax, cork wax, guaruma wax, rice germ oil wax, sugarcane wax, ouricury wax, or montan wax, animal waxes, such as beeswax, shellac wax, spermaceti, lanolin (wool wax), or uropygial grease, mineral waxes, such as ceresin or ozokerite (earth wax), or petrochemical waxes, such as petrolatum, paraffin waxes or microcrystalline waxes.

Chemically modified waxes include, for example, hard waxes, such as montan ester waxes, sassol waxes or hydrogenated jojoba waxes.

Synthetic waxes are generally understood as meaning polyalkylene waxes or polyalkylene glycol waxes. Meltable or softenable substances which can be used for the masses hardenable by cooling are also compounds from other classes of substance which satisfy said requirements with regard to the softening point. Synthetic compounds which have proven suitable are, for example, higher esters of phthalic acid, in particular dicyclohexyl phthalate, which is available commercially under the name Unimoll® 66 (Bayer AG). Also suitable are synthetically prepared waxes from lower carboxylic acids and fatty alcohols, for example dimyristyl tartrate, which is available under the name Cosmacol ETLP (Condea). Conversely, synthetic or partially synthetic esters of lower alcohols with fatty acids from native sources may also be used. This class of substance includes, for example, Tegin® 90 (Goldschmidt), glycerol monostearate palmitate. Shellac, for example Schellack-KPS-Dreiring-SP (Kalkhoff GmbH) can also be used as meltable or softenable substances.

Also covered by waxes within the scope of the present invention are, for example, the so-called wax alcohols. Wax alcohols are relatively high molecular weight, water-insoluble fatty alcohols having generally about 22 to 40 carbon atoms. The wax alcohols occur, for example, in the form of wax esters of relatively high molecular weight fatty acids (wax acids) as the major constituent of many natural waxes. Examples of wax alcohols are lignostearyl alcohol (1-tetracosanol), cetyl alcohol, myristyl alcohol or melissyl alcohol. The enclosure of the formulated zinc salts or crystalline sheet-like silicates can optionally also comprise wool wax alcohols, which is understood as meaning triterpenoic and steroid alcohols, for example lanolin, which is available, for example, under the trade name Argowax (Pamentier & Co). Within the scope of the present invention, further constituents of the meltable or softenable substances which may be used, at least in part, are fatty acid glycerol esters or fatty acid alkanolamines, but also, if desired, water-insoluble or only sparingly water-soluble polyalkylene glycol compounds.

Particularly preferred meltable or softenable substances are those from the group of polyethylene glycols (PEG) and/or polypropylene glycols (PPG), preference being given to polyethylene glycols with molar masses between 1500 and 36 000, particular preference being given to those with molar masses from 2000 to 6000, and special preference being given to those with molar masses from 3000 to 5000. Corresponding processes. which are characterized in that the plastically deformable mass(es) comprises/comprise at least one substance from the group of polyethylene glycols (PEGs) and/or polypropylene glycols (PPGs) are also preferred.

Preference is given here to coatings which comprise, as the sole meltable or softenable substances, propylene glycols (PPGS) and/or polyethylene glycols (PEGs). Polypropylene glycols (abbreviation PPGs) which can be used according to the invention are polymers of propylene glycol which satisfy the general formula below 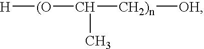
where n can assume values between 10 and 2000. Preferred PPGs have molar masses between 1000 and 10 000, corresponding to values of n between 17 and about 170.

Polyethylene glycols (abbreviations PEGs) which can be preferably used according to the invention are polymers of ethylene glycol which satisfy the general formula
H—(O—CH₂—CH₂)ₙ—OH
where n can assume values between 20 and about 1000. The above-mentioned preferred molecular weight ranges correspond here to preferred ranges of the value n in formula IV from about 30 to about 820 (precisely: from 34 to 818), particularly preferably from about 40 to about 150 (precisely: from 45 to 136) and in particular from about 70 to about 120 (precisely: from 68 to 113).

In a further preferred embodiment, the coating materials comprise paraffin wax.

Compared with the other named natural waxes, paraffin waxes have the advantage within the scope of the present invention that in an alkaline detergent environment no hydrolysis of the waxes takes place (as is to be expected, for example, in the case of the wax esters), since paraffin wax does not contain hydrolyzable groups.

Paraffin waxes consist primarily of alkanes, and low fractions of iso- and cycloalkanes. The paraffin to be used according to the invention preferably essentially has no constituents with a melting point of more than 70° C., particularly preferably of more than 60° C. Below this melting temperature in the detergent liquor, fractions of high-melting alkanes in the paraffin may leave behind undesired wax residues on the surfaces to be cleaned or on the ware to be cleaned. Such wax residues generally lead to an unattractive appearance of the cleaned surface and should therefore be avoided.

Meltable or softenable substances preferably to be processed comprise at least one paraffin wax with a melting range from 50° C. to 60° C., preferred coating materials being characterized in that they comprise a paraffin wax with a melting range from 50° C. to 55° C.

Preferably, the content of solid alkanes, isoalkanes and cycloalkanes which are solid at ambient temperature (generally about 10 to about 30° C.) in the paraffin wax used are as high as possible. The larger the amount of solid wax constituents in a wax at room temperature, the more useful the wax for the purposes of the present invention. As the proportion of solid wax constituents increases, so does the resistance of the process end-products toward impacts or friction on other surfaces, resulting in relatively long-lasting protection. High proportions of oils or liquid wax constituents can lead to a weakening of the coating, as a result of which pores are opened and the active substances are exposed to the ambient influences.

Besides paraffin as the main constituent, the meltable or softenable substances may also comprise one or more of the abovementioned waxes or wax-like substances. In a further preferred embodiment of the present invention, the mixture forming the meltable or softenable substances should be such that the mass and the coating formed therefrom are at least largely water-insoluble. At a temperature of about 30° C., the solubility in water should not exceed about 10 mg/l and should preferably be below 5 mg/l.

In such cases, however, the meltable or softenable substances should have the lowest possible solubility in water, even in water at elevated temperature, in order, as far as possible, to avoid temperature-dependent release of the active substances.

Preferred coating materials to be processed according to the invention are characterized in that they comprise, as meltable or softenable substances, one or more substances with a melting range from 40° C. to 75° C. in amounts of from 6 to 30% by weight, preferably from 7.5 to 25% by weight and in particular from 10 to 20% by weight, in each case based on the weight of the coating material.

Apart from through the choice of a suitable coating, the dissolution behavior of the zinc salt or silicate compound can also be influenced by the above-mentioned compacting processes. In this connection, besides the level of pressure used and the use of auxiliaries, such as, for example, of binders, the choice of the coformulated active and/or builder substances, in particular, is of great importance. For example, compacted silicates, in particular disilicates, and/or polycarboxylates and/or mixtures of different polycarboxylates based on their delayed dissolution/dispersion and based on any gelling of the substances or substance mixtures which arises in aqueous liquor are particularly suitable as “donor substances” for the zinc salts or crystalline sheet-like silicates.

A further type of formulation of dishwasher detergents or dishwasher detergent assistants according to the invention which is particularly preferred within the scope of the present application are polymer matrices. Such polymer matrices can be used universally in various program cycles, are characterized by a simple and cost-effective production method and can comprise varying amounts of active agent.

The present application therefore preferably also provides dishwasher detergents or dishwasher detergent assistants in which the zinc salt(s) and/or the crystalline sheet-like silicate(s) are present formulated in a polymer matrix.

The active ingredient-containing polymer matrices can be produced cost-effectively and in a great diversity of shapes. By choosing water-soluble or water-insoluble polymers, the composition according to the invention can even be formulated as a packaging of dishwasher detergents or as a basket into which the compositions are introduced. It is also possible to combine both types of introduction with one another by, for example, a carrier basket made of water-insoluble, active ingredient-containing polymer matrix containing a polymer body made of water-soluble, active ingredient-containing polymer matrix. Such products can release the active agents from the various matrices at different times to varying degrees, which leads to an optimum concentration of active substance at any time in the wash program.

If, in compositions preferred according to the invention, both the zinc salt and also the silicate are present formulated in a polymer matrix, then this formulation can, in preferred embodiments of the present invention, take place either in the same polymer matrix or else in different matrices, i.e. the zinc salt is present, for example, formulated in polymer A, while the silicate has been formulated in a polymer B. Finally, zinc salt and silicate can also be formulated by way of the same polymer, but in matrices which are separate from one another.

The compositions according to the invention can accordingly be realized both using water-insoluble and using water-soluble polymers or mixtures thereof. Preferred dishwasher detergents or dishwasher detergent assistants are characterized in that the polymer matrix includes one or more water-soluble polymer(s).

The polymer matrices according to the invention can be formulated universally. Thus, for example, it is possible to provide presoaking agents, prewash agents, detergents for the main wash cycle or rinse aids according to the invention. In addition, compositions according to the invention may also be combination products which combine two or more of the abovementioned agents. Formulation of compositions according to the invention as addition product which is suspended, for example, in the dishwasher is also possible without problems. The active ingredient-containing polymer matrix can be incorporated in particulate form into the compositions according to the invention, although it may also be a compact shaped body which, for example, is either a core which fills a depression of a detergent tablet, or a shaped body which is introduced into the dishwasher as addition product at the same time as a deodorant hanger. Baskets which are suitable for receiving detergent tablets can also be produced from the active ingredient-containing polymer matrix. Last but not least, the active ingredient-containing polymer matrix can also be used as a packaging for dishwashing detergents. This is particularly attractive for completely water-soluble active ingredient-containing polymer matrices since the consumer does not have to unpack the product, avoids direct contact with the product, which is viewed as undesirable, and additionally other packaging materials are saved.

Particularly preferred compositions according to the invention are characterized in that the polymer matrix comprises
a) 5 to 99.5% by weight of one or more polymers,
b) at least one zinc salt and at least one crystalline sheet-like silicate of the general formula (Ia)
   NaMSiₓO₂ₓ₊₁.y H₂O (Ia),
in which M is sodium or hydrogen, x is a number from 1.9 to 22, preferably from 1.9 to 4, and y is a number from 0 to 33, where the sum of the weight fractions of the zinc salt(s) and of the crystalline silicate(s) is 0.5 to 95% by weight,
c) 0 to 30% by weight of further active ingredients and/or auxiliaries,
where the weights given in each case refer to the total weight of the active ingredient-containing polymer matrix.

The polymer matrix of the compositions preferred according to the invention comprises 5 to 99.5% by weight of one or more polymers. Within the scope of the following application, in accordance with the IUPAC definition, the term “polymers” describes substances which are composed of macromolecules which collectively have a chemically uniform structure but which generally differ with regard to degree of polymerization, molecular mass and chain length. According to this IUPAC definition, which does not take into account the way in which the term has originated, a polymer is “a substance which is constructed from a large number of molecules in which one or more types of atoms or atom groups (so-called constitutive units, basic building blocks or repeat units) are arranged repetitively next to one another”. The variously sized macromolecules of a polymer are constructed from sufficiently identical or similar low molecular weight building blocks (monomers) for the physical properties of the substance, particularly the viscoelasticity, to no longer change noticeably if the number of building blocks is slightly increased or reduced. The size of the macromolecules means that the end groups have relatively little effect on the properties of the polymers, meaning that in most cases they are not given explicitly in the structural formulae given below.

The polymers of the compositions according to the invention which form the matrix may here either be of natural origin or of synthetic origin. Preferred compositions according to the invention are characterized in that the polymer matrix comprises 7.5 to 95% by weight, preferably 10 to 90% by weight, particularly preferably 12.5 to 85% by weight, further preferably 15 to 82.5% by weight and in particular 20 to 80% by weight, of one or more polymers, the weight data referring to the active ingredient-containing polymer matrix.

The average molar mass of the polymers present in the preferred compositions according to the invention is preferably at least 5000 g/mol, particularly preferably at least 10 000 g/mol and in particular at least 12 000 g/mol.

As already mentioned, the compositions preferred according to the invention can comprise either water-insoluble or water-soluble polymers and mixtures of these polymers. Compositions preferred according to the invention based on water-insoluble polymer matrices are characterized in that the polymer matrix comprises one or more water-insoluble polymers from the group consisting of polyethylene, polypropylene, polytetrafluoroethylene, polystyrene, polyethylene terephthalate, polycarbonate, polyvinyl chloride, the polyurethanes, polyamides and mixtures thereof.

Instead of water-insoluble polymers or in mixture with them, it is also possible for water-soluble polymers of natural or synthetic origin to form the polymer matrix. Further preferred compositions according to the invention are characterized in that the polymer matrix comprises one or more water-insoluble polymers, where the water-soluble polymer(s) is/are preferably chosen from:
i) polyacrylic acids and salts thereof
ii) polymethacrylic acids and salts thereof
iii) polyvinylpyrrolidone,
iv) vinylpyrrolidone/vinyl ester copolymers,
v) cellulose ethers
vi) polyvinyl acetates, polyvinyl alcohols and their copolymers
vii) graft copolymers of polyethylene glycols and vinyl acetate
viii) alkylacrylamide/acrylic acid copolymers and salts thereof
ix) alkylacrylamide/methacrylic acid copolymers and salts thereof
x) alkylacrylamide/methylmethacrylic acid copolymers and salts thereof
xi) acrylacrylamide/acrylic acid/alkylaminoalkyl(meth)acrylic acid copolymers and salts thereof
xii) acrylacrylamide/methacrylic acid/alkylamino(meth)acrylic acid copolymers and salts thereof
xiii) alkylacrylamide/methylmethacrylic acid/alkylaminoalkyl(meth)acrylic acid copolymers and salts thereof
xiv) alkylacrylamide/alkyl methacrylate/alkylaminoethyl methacrylate/alkyl methacrylate copolymers and salts thereof
xv) copolymers of
   xv-i) unsaturated carboxylic acids and salts thereof
   xv-ii) cationically derivatized unsaturated carboxylic acids and salts thereof
xvi) alkylamidoalkyltrialkylammonium chloride/acrylic id copolymers and alkali metal and ammonium salts thereof
xvii) alkylamidoalkyltrialkylammonium chloride/methacrylic id copolymers, and alkali metal and ammonium salts thereof
xviii) methacroylethylbetaine/methacrylate copolymers
xix) vinyl acetate/crotonic acid copolymers
xx) acrylic acid/ethyl acrylate/N-tert-butylacrylamide terpolymers
xxi) graft polymers of vinyl esters, esters of acrylic acid or methacrylic acid on their own or in a mixture, copolymerized with crotonic acid, acrylic acid or methacrylic acid with polyalkylene oxides and/or polyalkylene glycols
xxii) grafted copolymers from the copolymerization of
   xxii-i) at least one monomer of the non-ionic type,
   xxii-ii) at least one monomer of the ionic type,
xxiii) copolymers obtained by copolymerization of at least one monomer of each of the three following groups:
   xxiii-i) esters of unsaturated alcohols and short-chain saturated carboxylic acids and/or esters of short-chain saturated alcohols and unsaturated carboxylic acids,
   xxiii-i) unsaturated carboxylic acids,
   xxiii-iii) esters of long-chain carboxylic acids and unsaturated alcohols and/or esters of the carboxylic acids of group d6ii) with saturated or unsaturated, straight-chain or branched C₈₋₁₈ alcohols.

Besides the polymer(s), the active ingredient-containing polymer matrix has a content of at least one zinc salt and/or at least one crystalline sheet-like silicate of the general formula (I) or of the general formula (Ia) which can be released from the matrix. Compositions preferred according to the invention are characterized in that they comprise at least one zinc salt and at least one crystalline sheet-like silicate of the general formula (I) or of the general formula (Ia), where the sum of the weight fractions of these constituents is 1 to 90% by weight, preferably 1.5 to 80% by weight, particularly preferably 2 to 70% by weight, further preferably 2.5 to 60% by weight and in particular 3 to 50% by weight, in each case based on the total weight of the active ingredient-containing polymer matrix.

The dishwasher detergents or dishwasher detergent assistants according to the invention can comprise the active ingredient-containing polymer matrix in varying amounts. Depending on whether the active ingredient-containing polymer matrix is present in the compositions for example in the form of a finely divided powder or granules, is formed as part of a shaped body, or whether it includes the composition as packaging, the quantitative fractions of the active ingredient-containing polymer matrix in the overall composition can vary. Preference is given here to compositions according to the invention which, based on the total mass of the composition, comprise 1 to 40% by weight, preferably 1.5 to 35% by weight, particularly preferably 2 to 30% by weight and in particular 2.5 to 20% by weight, of the active ingredient-containing polymer matrix.

Particularly preferred polymer matrices comprise at least one zinc salt in amounts such that the composition comprises zinc in oxidized form in weight fractions of from 0.01 to 1% by weight, preferably from 0.02 to 0.5% by weight and in particular from 0.04 to 0.2% by weight, in each case based on the total weight of the polymer matrix.

As mentioned at the start, the incorporation of active ingredient-containing polymer matrices preferred according to the invention into the compositions according to the invention does not lead to any limitation with regard to the supply forms or the formulations of these compositions. Thus, besides customary dishwasher detergents, presoak or prewash products, rinse aids, machine-care compositions or additional products can be provided in the form of a composition according to the invention. One preferred embodiment of the composition according to the invention envisages that the polymer matrix is provided as a molding to be introduced separately into the dishwasher and which releases the agents from the polymer matrix over several wash cycles. This molding can either be a dosing basket for other products, such as, for example, the detergent, but it may also embody the additional uses of glass protection as a separate and independent molding. Possible shapes are, for example, close to the known dishwasher deodorants. Configuration of the plastic section in translucent, opalescent or completely clear form, for example in the form of a stylized diamond, is visually attractive. Such product configurations enable the consumer to visualize the shine resulting from the glass protection.

The diversity of the shaping is not subject to any limitations due to the options for plastics processing. The active ingredient-containing polymer matrices can be shaped without problems using current methods.

The shaping takes place by processes customary in the plastics processing industry, preference being given in particular to film production and further processing, blow molding and extrusion molding. A common feature of all of these processes is that plastic granules are melted using an extruder and passed to the shaping tools. Here, the plastic granules may already comprise the agents for the inhibition of glass corrosion, although these can also be added during melting in the extruder, which permits a particularly cost-effective production of the active ingredient-containing polymer matrices preferred according to the invention.

In an additional preferred embodiment, the dishwasher detergents or dishwasher detergent assistants according to the invention are formulated in a way which allows the active substances present within these compositions to be applied and dosed in a targeted manner. Within the scope of the present application, of particular suitability for this purpose are stick-like supply forms which, like an adhesive stick, do not change their spatially-geometric shape during storage and transportation, but loses this shape if the supply form is moved under the action of a pressure over a surface, in its contact area with the surface due to the shear forces which arise there. As a result of the acting shear forces, the composition is smeared on the surface and remains there when the effect of the shear forces has stopped in its new spatially-geometric shape, is thus again dimensionally stable. Using such a preferred formulation it is possible to apply and dose compositions according to the invention in a targeted manner.

Such dimensionally stable dishwasher detergents or dishwasher detergent assistants which can be spread on a surface due to their material nature under the action of a shear force, but maintain their three-dimensional shape without the action of a shear force can advantageously be characterized by their penetration numbers. Within the scope of the present invention, the penetration number is defined as the numerical value which arises when determining the hardness of the composition according to the invention by means of a Texture Analyzer, model TA-XT2-I from Stable Micro Systems. To carry out this measurement, the following test parameters are set:

| TA mode: | measurement force in direction of pressure |
|---|---|
| TA option: | simple test |
| Trigger value | 0.2 g |
| PPS | 200 |

The penetration number is determined by pressing a certain measurement tool (TA-15 45° cone made of stainless steel) into the test material at a defined feed rate (0.5 mm/s) to a defined penetration depth (5.0 mm) and then drawn out of this material again at a defined rate (0.2 mm/s). The investigated test materials had a temperature of 23° C., the measurements were carried out at 20° C. room temperature. Starting from the described experimental set-up, the measuring device ascertained a numerical value in the unit of grams [g]. For the purposes of the present application, this numerical value is defined as the penetration number. The measurements by the described method revealed then that the preferred dimensionally stable dishwasher detergents or dishwasher detergent assistants have penetration numbers of from 200 to 1000 g, preferably from 250 to 900 g, particularly preferably from 300 to 800 g and in particular from 350 to 700 g.

The present invention therefore further preferably provides dishwasher detergents or dishwasher detergent assistants according to the invention which are dimensionally stable and have a penetration number of from 200 to 1000 g, preferably from 200 to 900 g, particularly preferably from 300 to 800 g and in particular from 350 to 700 g.

Within the scope of the present invention, the term “dimensionally stable” describes dishwasher detergents or dishwasher detergent assistants which have intrinsic dimensional stability which enables them to have a fracture-stable, nondisintegrating three-dimensional shape under customary conditions of manufacture, storage, transportation and handling by the consumer which does not change even under the conditions stated over a prolonged period, i.e. under the customary conditions of manufacture, storage, transportation and handling by the consumer maintains the spatially-geometric shape produced by the manufacture, i.e. for example does not liquefy.

The penetration number of from 200 to 1000 g typical of preferred compositions according to the invention cannot be realized by active substances such as zinc salts or sheet-like silicates in their pure form. It is therefore necessary to provide a carrier material or matrix material for these active substances which corresponds to said physical requirements on a composition according to the invention. In addition, such a matrix should be compatible with active agents present within it, i.e. in particular not react with them, but stabilize them. In addition, the carrier materials should not jeopardize the desired washing operation, thus also be compatible with all other substances used during the washing and/or care operation. Finally, the matrix material should preferably be water-soluble or water-dispersible in order to avoid residues appearing following use of the composition according to the invention. Of particular preference are carrier materials which, besides the function of a matrix for the active substance, at the same time have a washing or care function. From the large number of possible carrier materials, a number of substance groups have proven to be particularly advantageous within the scope of the present invention. These substances will be discussed in more detail below.

Preferably dimensionally stable dishwasher detergents or dishwasher detergent assistants according to the invention are therefore characterized within the scope of the present application in that they comprise polyvinylpyrrolidone(s) and/or polyvinyl alcohol(s) and/or polyvinyl acetate(s) and/or polyacrylate(s) and/or polyalkylene glycol(s) and/or fat(s) and/or fatty acid(s) and/or fatty acid esters and/or fatty acid amide(s) and/or fatty alcohols and/or wax(es) and/or paraffin(s) and/or wax alcohols and/or surfactant(s), preferably nonionic surfactant(s) and/or dextrin(s) and/or starch ethers, where the weight fraction of this constituent/these constituents of the total weight of the dimensionally stable dishwasher detergent and/or dishwasher assistant is preferably between 30 and 99% by weight, particularly preferably between 40 and 95% by weight and in particular between 50 and 95% by weight.

Dishwasher detergents or dishwasher detergent assistants according to the invention can also be formulated in the form of a liquid or flowable composition as well as in the described solid or dimensionally stable forms. In a further preferred embodiment of the present invention, the dishwasher detergents or dishwasher detergent assistants therefore have a viscosity of from 500 to 500 000 mPas, preferably from 900 to 200 000 mPas and in particular from 1300 to 100 000 mPas. The viscosity of the compositions according to the invention is measured using customary standard methods (for example Brookfield viscometer LVT-II at 20 rpm and at 20° C., spindle 3). The expression “liquid or flowable composition” is used below for compositions which have a viscosity of from 500 to 500 000 mPas, preferably from 900 to 200 000 mPas and in particular from 1300 to 100 000 mPas.

As a preferred ingredient, such preferred liquid or flowable compositions according to the invention comprise one or more nonaqueous solvents. These originate, for example, from the groups of monoalcohols, diols, triols or polyols, ethers, esters and/or amides. Particular preference is given here to nonaqueous solvents which are water-soluble, where “water-soluble” solvents for the purposes of the present application are solvents which are completely miscible with water at room temperature, i.e. without miscibility gap.

Suitable nonaqueous solvents preferably originate from the group of mono- or polyhydric alcohols, alkanolamines or glycol ethers, provided they are miscible with water in the given concentration range. The solvents are preferably chosen from ethanol, n- or isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, 1-butoxyethoxy-2-propanol, 3-methyl-3-methoxybutanol, propylene glycol t-butyl ether, and mixtures of these solvents.

Nonionic surfactants which are liquid at room temperature are also preferred nonaqueous solvents within the scope of the application.

A liquid or flowable dishwasher detergent or dishwasher detergent assistant which is particularly preferred within the scope of the present invention is characterized in that it comprises nonaqueous solvent(s), where the solvent(s) is/are preferably chosen from the group of polyethylene glycols and polypropylene glycols, glycerol, glycerol carbonate, triacetin, ethylene glycol, propylene glycol, propylene carbonate, hexylene glycol, ethanol and n-propanol and/or isopropanol.

Polyethylene glycols (abbreviation PEGs) which can preferably be used according to the invention are liquid at room temperature. PEGs are polymers of ethylene glycol which satisfy the general formula (II)
H—(O—CH₂—CH₂)ₙ—OH (II),
where n can assume values between 1 (ethylene glycol, see below) and about 16. For polyethylene glycols there exist various nomenclatures, which may lead to confusion. It is common in the art to state the average relative molecular weight after the letters “PEG”, so that “PEG 200” characterizes a polyethylene glycol with a relative molar mass about 190 to about 210. In accordance with this nomenclature, the polyethylene glycols PEG 200, PEG 300, PEG 400 and PEG 600 customary in the art can be used within the scope of the present invention.

For cosmetic ingredients a different nomenclature is used, in which the abbreviation PEG is provided with a hyphen and the hyphen is followed directly by a number which corresponds to the number n in the above formula. According to this nomenclature (so-called INCI nomenclature, CTFA International Cosmetic Ingredient Dictionary and Handbook, 5th Edition, The Cosmetic, Toiletry and Fragrance Association, Washington, 1997), for example, PEG-4, PEG-6, PEG-8, PEG-9, PEG-10, PEG-12, PEG-14 and PEG-16 can be used in accordance with the invention.

Polyethylene glycols are commercially available, for example under the trade names Carbowax® PEG 200 (Union Carbide), Emkapol® 200 (ICI Americas), Lipoxol® 200 MED (HÜLS America), Polyglycol® E-200 (Dow Chemical), Alkapol® PEG 300 (Rhone-Poulenc), Lutrol® E300 (BASF), and the corresponding trade names with higher numbers.

Polypropylene glycols (PPGs) which can be used according to the invention are polymers of propylene glycol which satisfy the general formula (III) 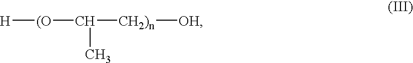
where n can assume values between 1 (propylene glycol, see below) and about 12. Of industrial significance here are, in particular, di-, tri- and tetrapropylene glycol, i.e. the representatives where n=2, 3 and 4 in the above formula.

Glycerol is a colorless, clear, viscous, odorless, sweet-tasting hygroscopic liquid which has a density of 1.261 and solidifies at 18.2° C. Glycerol was originally only a by-product of fat saponification, but is nowadays synthesized industrially in large quantities. Most industrial processes start from propene, which is processed to glycerol via the intermediate stages of allyl chloride and epichlorohydrin. A further industrial process is the hydroxylation of allyl alcohol with hydrogen peroxide over a WO₃ catalyst, via the stage of the glycide.

Glycerol carbonate is obtainable by esterifying ethylene carbonate or dimethyl carbonate with glycerol, the by-products produced being ethylene glycol or methanol, respectively. A further synthesis route starts from glycidol (2,3-epoxy-1-propanol), which is reacted with CO₂ under pressure in the presence of catalysts to give glycerol carbonate. Glycerol carbonate is a clear, readily mobile liquid which has a density of 1.398 gcm⁻³ and boils at 125-130° C. (0.15 mbar).

Ethylene glycol (1,2-ethanediol, “glycol”) is a colorless, viscous, sweet-tasting, highly hygroscopic liquid which is miscible with water, alcohols and acetone and has a density of 1.113. The solidification point of ethylene glycol is −11.5° C.; the liquid boils at 198° C.

Industrially, ethylene glycol is obtained from ethylene oxide by heating with water under pressure. Promising preparation processes may be based on the acetoxylation of ethylene and subsequent hydrolysis, or on synthesis gas reactions.

Propylene glycol exists in two isomers, 1,3-propanediol and 1,2-propanediol. 1,3-Propanediol (trimethylene glycol) is a neutral, colorless and odorless, sweet-tasing liquid with a density of 1.0597 which solidifies at −32° C. and boils at 214° C. 1,3-Propanediol is prepared from acrolein and water with subsequent catalytic hydrogenation.

Of far more industrial importance is 1,2-propanediol (propylene glycol), which is an oily, colorless, virtually odorless liquid of density 1.0381 which solidifies at −60° C. and boils at 188° C. 1,2-Propanediol is prepared from propylene oxide by water addition.

Propylene carbonate is a water-white, readily mobile liquid with a density of 1.21 gcm⁻³, a melting point of −49° C. and a boiling point of 242° C. Propylene carbonate is also accessible industrially by reacting propylene oxide and CO₂ at 200° C. and 80 bar.

In preferred liquid or flowable dishwasher detergents or dishwasher detergent assistants according to the invention, the nonaqueous solvent(s) is/are present in amounts of from 0.1 to 70% by weight, preferably from 0.5 to 60% by weight, particularly preferably from 1 to 50% by weight, very particularly preferably from 2 to 40% by weight and in particular from 2.5 to 30% by weight, in each case based on the total composition.

Within the scope of this invention, “nonaqueous” is understood here as meaning a state in which the content of free water in the compositions is significantly below 5% by weight. It is preferred for the content of free water, i.e. water not in the form of water of hydration and/or water of constitution, in the dishwasher detergents or dishwasher detergent assistants according to the invention to be less than 10% by weight, preferably less than 8% by weight and in particular even less than 6% by weight, in each case based on the composition. Accordingly, water may be introduced into the composition essentially only in chemically and/or physically bound form or as a constituent of the solid raw materials or compounds, but not as a liquid, solution or dispersion.

As a further preferred ingredient, preferred liquid or flowable dishwasher detergents or dishwasher detergent assistants according to the invention comprise one or more nonionic surfactants. According to the invention, the amounts in which the nonionic surfactants are used are preferably between 5 and 30% by weight, particular preference being given to those compositions according to the invention which comprise 1 to 25% by weight, more preferably 2 to 22.5% by weight, particularly preferably 3 to 20% by weight and in particular 4 to 17.5% by weight, of nonionic surfactant(s).

For a more detailed description of these nonionic surfactants, reference is made at this point to the following statements about preferred washing and cleaning active ingredients of preferred compositions according to the invention, in order to avoid repetition.

To regulate the viscosity, the compositions according to the invention can comprise further ingredients, the use of which can, for example, control the settling behavior or the pourability or flowability in a targeted manner. In nonaqueous systems, combinations of structure-imparting agents and thickeners in particular have proven successful.

Dishwasher detergents preferred for the purposes of the present invention further comprise
a) 0.1 to 1.0% by weight of one or more structure-imparting agents from the group of bentonites and/or at least partially etherified sorbitols and
b) 5.0 to 30% by weight of one or more thickeners from the group of carbonates, sulfates and amorphous or crystalline disilicates.

The structure-imparting agent a) originates from the group of bentonites and/or at least partially etherified sorbitols. These substances are used in order to ensure the physical stability of the compositions and to adjust the viscosity. Although conventional thickeners such as polyacrylates or polyurethanes do not work in nonaqueous media, viscosity regulation is possible using said substances in the nonaqueous system.

Bentonites are contaminated clays which are formed as a result of the weathering of vulcanic tuffs. Because of their high content of montmorillonite, bentonites have valuable properties, such as swellability, ion exchangeability and thixotropy. Here, it is possible to correspondingly modify the properties of the bentonites to the intended use. Bentonites are often as clay constituent in tropical soils and are recovered as sodium bentonite e.g. in Wyoming/USA. Sodium bentonite has the most favorable application properties (swellability), meaning that its use for the purposes of the present invention is preferred. Naturally occurring calcium bentonites originate, for example, from Mississippi/USA or Texas/USA or from Landshut/Germany. The naturally obtained Ca bentonites are converted artificially into the more swellable Na bentonites by exchanging Ca with Na.

The main constituents of the bentonites are formed by so-called montmorillonites which can also be used in pure form for the purposes of the present invention. Montmorillonites are clay minerals which belong to the phyllosilicates and here to the dioctahedral smectites and produce monoclinic-pseudohexagonal crystals. Montmorillonites form predominantly white, gray-white to yellowish masses which appear completely amorphous, are readily friable, which swell in water but do not become plastic and which can be described by the general formulae
Al₂[(OH)₂/Si₄O₁₀].nH₂O or
Al₂O₃.4SiO₂.H₂O.nH₂O or
Al₂[(OH)₂/Si₄O₁₀] (dried at 150°).

Preferred dishwasher detergents or dishwasher detergent assistants are characterized in that the structure-imparting agents used are montmorillonites. Montmorillonites have a three-layer structure which consists of two tetrahedron layers which are electrostatically crosslinked via the cations of an intermediate octahedron layer. The layers are not connected in rigid fashion, but can swell as a result of reversible intercalation of water (in 2-7 times the amount) and other substances such as, for example, alcohols, glycols, pyridine, α-picoline, ammonium compounds, hydroxyaluminosilicate ions etc. The formulae given above represent only approximated formulae since montmorillonites have a great capacity for ion exchange. Thus, Al can be exchanged for Mg, Fe²⁺, Fe³⁺, Zn, Cr, Cu and other ions. The result of such a substitution is a negative charge of the layers, which is balanced by other cations, in particular Na⁺ and Ca²⁺.

In combination with the bentonites or as a replacement for them, if their use is not desired, it is possible to use at least partially etherified sorbitols as structure-imparting agents.

Sorbitol is a 6-hydric alcohol (sugar alcohol) belonging to the hexitols which relatively readily eliminates one or two mol of water intramolecularly and forms cyclic ethers (for example sorbitan and sorbide). The elimination of water is also possible intermolecularly, with noncyclic ethers forming from sorbitol and the alcohols in question. Here too, the formation of monoethers and bisethers is possible, it also being possible for higher degrees of etherification such as 3 and 4 to arise. At least partially etherified sorbitols to be used with preference for the purposes of the present invention are dietherified sorbitols, of which particular preference is given to dibenzylidenesorbitol. Preference is given here to dishwasher detergents which comprise dietherified sorbitols, in particular dibenzylidenesorbitol, as structure-imparting agent.

The preferred liquid or flowable compositions according to the invention can comprise the structure-imparting agents in amounts of from 0.1 to 1.0% by weight, based on the total composition and on the active substance of the structure-imparting agent. Preferred compositions comprise the structure-imparting agent in amounts of from 0.2 to 0.9% by weight, preferably in amounts of from 0.25 to 0.75% by weight and in particular in amounts of from 0.3 to 0.5% by weight, in each case based on the total composition.

As thickeners, the preferred liquid or flowable compositions according to the invention can comprise inorganic salts from the group of carbonates, sulfates and amorphous or crystalline disilicates. In this connection, it is in principle possible to use said salts of all metals, preference being given to the alkali metal salts. For the purposes of the present invention, the thickeners particularly preferably used are alkali metal carbonate(s), alkali metal sulfate(s) and/or amorphous and/or crystalline alkali metal disilicate(s), preferably sodium carbonate, sodium sulfate and/or amorphous or crystalline sodium disilicate.

The preferred liquid or flowable compositions according to the invention comprise the thickeners in amounts of from 5 to 30% by weight, based on the total composition. Particularly preferred compositions comprise the thickener or thickeners in amounts of from 7.5 to 28% by weight, preferably in amounts of from 10 to 26% by weight and in particular in amounts of from 12.5 to 25% by weight, in each case based on the total composition.

With regard to an increased settling stability, it is preferred for the solids present in the compositions according to the invention to be used in as finely divided a form as possible. This is particularly advantageous for the inorganic thickeners and the bleaches. Preference is given here to dishwasher detergents according to the invention in which the average particle size of the bleaches and thickeners and of the optionally used builders is less than 75 μm, preferably less than 50 μm and in particular less than 25 μm.

The liquid dishwasher detergents according to the invention can also comprise other viscosity regulators or thickeners to establish any desired higher viscosity. In this connection, it is possible to use all known thickeners, i.e. those based on natural or synthetic polymers.

Naturally occurring polymers which are used as thickeners are, for example, agar agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples which may be mentioned here being carboxymethylcellulose and other cellulose ethers, hydroxyethylcellulose and hydroxypropylcellulose, and carob flour ether.

Liquid or flowable dishwasher detergents or dishwasher detergent assistants which are preferred within the scope of the present invention comprise, as thickener, hydroxyethylcellulose and/or hydroxypropylcellulose, preferably in amounts of from 0.01 to 4.0% by weight, particularly preferably in amounts of from 0.01 to 3.0% by weight and in particular in amounts of from 0.01 to 2.0% by weight, in each case based on the total composition.

A large group of thickeners which are used widely in very diverse fields of application are the completely synthetic polymers, such as polyacrylic and polymethacrylic compounds, vinyl polymers, polycarboxylic acids, polyethers, polyimines, polyamides and polyurethanes.

Thickeners from said classes of substance are commercially broadly available and are obtainable, for example, under the trade names Acusol®-820 (methacrylic acid (stearyl alcohol-20 EO) ester-acrylic acid copolymer, 30% strength in water, Rohm & Haas), Dapral®-GT-282-S (alkyl polyglycol ether, Akzo), Deuterol® polymer-11 (dicarboxylic acid copolymer, Schö(ner GmbH), Deuteron®-XG (anionic heteropolysaccharide based on β-D-glucose, D-manose, D-glucuronic acid, Schöner GmbH), Deuteron®-XN (nonionogenic polysaccharide, Schöner GmbH), Dicrylan® thickener-O (ethylene oxide adduct, 50% strength in water/isopropanol, Pfersse Chemie), EMA®-81 and EMA®-91 (ethylene-maleic anhydride copolymer, Monsanto), thickener-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell) and Shellflo®-XA (xanthan biopolymer, stabilized with formaldehyde, Shell).

A preferred polymeric thickener is xanthan, a microbial anionic heteropolysaccharide which is produced by Xanthomonas campestris and some other species under aerobic conditions and has a molar mass of from 2 to 15 million daltons. Xanthan is formed from a chain with β,4-bonded glucose (cellulose) with side chains. The structure of the subgroups consists of glucose, mannose, glucuronic acid, acetate and pyruvate, where the number of pyruvate units determines the viscosity of the xanthan.

Thickeners likewise to be used preferably for the purposes of the present invention are polyurethanes or modified polyacrylates which, based on the total product, can be used, for example, in amounts of from 0.1 to 5% by weight.

Polyurethanes (PURs) are prepared by polyaddition from di- or polyhydric alcohols and isocyanates and can be described by the general formula IV 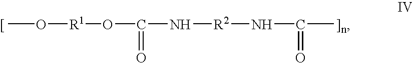
in which R¹ is a low molecular weight or polymeric diol radical, R² is an aliphatic or aromatic group and n is a natural number. R¹ here is preferably a linear or branched C₂₋₁₂-alk(en)yl group, but can also be a radical of a polyhydric alcohol, as a result of which crosslinked polyurethanes are formed which differ from the formula VIII given above by virtue of the fact that further —O—CO—NH groups are bonded to the radical R¹.

Industrially important PURs are prepared from polyester- and/or polyetherdiols and, for example, e.g. from toluene 2,4- or 2,6-diisocyanate (TDI, R²═C₆H₃-CH₃), 4,4′-methylenedi(phenylisocyanate) (MDI, R²═C₆H₄—CH₂—C₆H₄) or hexamethylene diisocyanate [HMDI, R²═(CH₂)₆].

Standard commercial thickeners based on polyurethane are available, for example, under the names Acrysol®PM 12 V (mixture of 3-5% modified starch and 14-16% PUR resin in water, Rohm & Haas), Borchigel® L75-N (nonionogenic PUR dispersion, 50% strength in water, Borchers), Coatex® BR-100-P (PUR dispersion, 50% strength in water/butyl glycol, Dimed), Nopco® DSX-1514 (PUR dispersion, 40% strength in water/butyl triglycol, Henkel-Nopco), thickener QR 1001 (20% strength PUR emulsion in water/diglycol ether, Rohm & Haas) and Rilanit® VPW-3116 (PUR dispersion, 43% strength in water, Henkel). For the purposes of the present invention, when using aqueous dispersions it is to be ensured that the water content of the products according to the invention remains within the limits given above. If the use of aqueous dispersions is not possible for these reasons, dispersions in other solvents, or else the solids, may be used.

Modified polyacrylates which can be used for the purposes of the present invention are derived, for example, from acrylic acid or from methacrylic acid and can be described by the general formula V 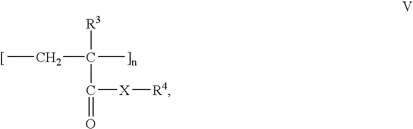
in which R³ is H or a branched or unbranched C₁₋₄-alk(en)yl radical, X is N—R⁵ or O, R⁴ is an optionally alkoxylated branched or unbranched, possibly substituted C₈₋₂₂-alk(en)yl radical, R⁵ is H or R⁴ and n is a natural number. Generally, such modified polyacrylates are esters or amides of acrylic acid or of an α-substituted acrylic acid. Among these polymers, preference is given to those in which R³ is H or a methyl group. In the polyacrylamides (X═N—R⁵), either mono- (R⁵═H) or di- (R⁵═R⁴) N-substituted amide structures are possible, where the two hydrocarbon radicals which are bonded to the N atom can be chosen independently of one another from optionally alkoxylated branched or unbranched C₈₋₂₂-alk(en)yl radicals. Among the polyacrylic esters (X═O), preference is given to those in which the alcohol has been obtained from natural or synthetic fats or oils and has additionally been alkoxylated, preferably ethoxylated. Preferred degrees of alkoxylation are between 2 and 30, particular preference being given to degrees of alkoxylation between 10 and 15.

Since the polymers which can be used are industrial compounds, the designation of the radicals bonded to X represents a statistical average value which can vary in individual cases with regard to chain length or degree of alkoxylation. Formula V gives merely formulae for idealized homopolymers. However, for the purposes of the present invention, it is also possible to use copolymers in which the proportion of monomer units which satisfy formula V is at least 30% by weight. Thus, for example, copolymers of modified polyacrylates and acrylic acid or salts thereof which also have acidic H atoms or basic —COO⁻ groups can also be used.

Modified polyacrylates which are preferably to be used for the purposes of the present invention are polyacrylate-polymethacrylate copolymers which satisfy the formula Va 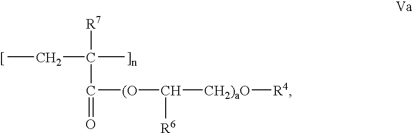
in which R⁴ is a preferably unbranched, saturated or unsaturated C₈₋₂₂-alk(en)yl radical, R⁶ and R⁷, independently of one another, are H or CH₃, the degree of polymerization n is a natural number and the degree of alkoxylation a is a natural number between 2 and 30, preferably between 10 and 20. R⁴ is preferably a fatty alcohol radical which has been obtained from natural or synthetic sources, the fatty alcohol in turn preferably being ethoxylated (R⁶═H).

Products of the formula Va are commercially available, for example under the name Acusol® 820 (Rohm & Haas) in the form of 30% strength by weight dispersions in water. In the case of said commercial product, R⁴ is a stearyl radical, R⁶ is a hydrogen atom, R⁷ is H or CH₃ and the degree of ethoxylation a is 20. That stated above with regard to the water content of the products also applies for this dispersion.

Liquid or flowable dishwasher detergents or dishwasher detergent assistants preferred for the purposes of the present invention are characterized in that they additionally comprise 0.01 to 5% by weight, preferably 0.02 to 4% by weight, particularly preferably 0.05 to 3% by weight and in particular 0.1 to 1.5% by weight, of a polymeric thickener, preferably from the group of polyurethanes or of modified polyacrylates, particular preferably thickeners of the formula VI 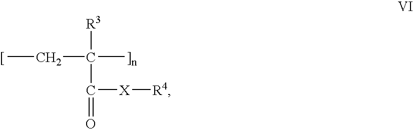
in which R³ is H or a branched or unbranched C₁₋₄-alk(en)yl radical, X is N—R⁵ or O, R⁴ is an optionally alkoxylated branched or unbranched, possibly substituted C₈₋₂₂-alk(en)yl radical, R⁵ is H or R⁴ and n is a natural number.

The solid or dimensionally stable and liquid or flowable dishwasher detergents or dishwasher detergent assistants according to the invention can be supplied to the consumer in conventional containers, for example bottles, screw glassware, canisters, balloons, beakers or spray vessels, from which he meters these for use. Relatively high viscosity compositions can also be supplied in tubes or metered dispensers, as are known for toothpaste or sealing compositions. Such containers are nowadays usually prepared from non-water-soluble polymers and can, for example, consist of all customary water-insoluble packaging materials which are well known to the person skilled in the art in this field. Preferred polymers which may be mentioned here are, in particular, hydrocarbon-based plastics. Particularly preferred polymers include polyethylene, polypropylene (more preferably oriented polypropylene) and polymer mixtures, such as, for example, mixtures of said polymers with polyethylene terephthalate. Also suitable are one or more polymers from the group consisting of polyvinyl chloride, polysulfones, polyacetals, water-insoluble cellulose derivatives, cellulose acetate, cellulose propionate, cellulose acetobutyrate and mixtures of said polymers or copolymers comprising said polymers.

A particularly preferred embodiment of the present invention, however, aims to lend the consumer a helping hand in the form of preportioned compositions according to the invention so that he can utilize the dosing advantages known to him from the “tablet” supply form, and combine them with the rapid dissolution and release rate and the performance advantages of the compositions according to the invention. Such preportioned compositions according to the invention can likewise be in the form of water-insoluble packagings, so that the consumer has to open these prior to use in a suitable manner. It is, however, also possible and preferred to package portioned compositions according to the invention so that the consumer can place them into the dishwasher directly, i.e. together with the packaging, without further handling steps. Such packagings include water-soluble or water-disintegrable packagings such as pouches made of water-soluble film, pouches or other packagings made of water-soluble or water-disintegrable nonwovens or else flexible or rigid bodies made of water-soluble polymers, preferably in the form of filled hollow bodies which can be produced, for example, by deep-drawing, injection molding, blow molding, calendering etc.

The present invention thus preferably provides dishwasher detergents or dishwasher detergent assistants according to the invention which are packaged in portions in a water-soluble enclosure.

Dishwasher detergents or dishwasher detergent assistants according to the invention preferably comprise an enclosure which is completely or partially soluble in water. The shape of the enclosure is not limited to particular shapes. In principle, all archimedic and platonic bodies, i.e. three-dimensional shaped bodies, are suitable as enclosure shapes. Examples of the shape of the enclosure are capsules, cubes, spheres, egg-shaped bodies, cuboids, cones, rods or pouches. Hollow bodies with one or more compartments are also suitable as enclosure for the dishwasher detergents. In preferred embodiments of the invention, the enclosures have the form of capsules, as are also used, for example, in pharmacy for administering medicaments, of spheres or of pouches. The latter are preferably sealed or adhered on at least one side, where the adhesive used in particularly preferred embodiments of the invention is an adhesive which is water-soluble.

According to a preferred embodiment of the invention, the water-soluble polymer material partially or completely surrounding the dishwasher detergent or dishwasher detergent assistant is a water-soluble packaging. This is understood as meaning a flat component which partially or completely surrounds the dishwasher detergent. The exact shape of such a packaging is not critical and can be adapted largely to the use conditions.

For example, processed plastic films or sheets, capsules and other conceivable shapes worked into different shapes (such as tubes, sachets, cylinders, bottles, disks or the like) are suitable. According to the invention, particular preference is given to films which can be adhered and/or sealed, for example, to give packagings such as tubes, sachets or the like after they have been filled with part portions of the detergents according to the invention or with the detergents according to the invention themselves.

Also preferred according to the invention are plastic film packagings made of water-soluble polymer. materials due to the properties which can be matched in an excellent manner to the desired physical conditions. Such films are known in principle from the prior art.

In summary, hollow bodies of any shape, which can be produced by injection molding, bottle blowing, deep-drawing etc., and also hollow bodies made of films, in particular pouches, are preferred as packagings for portioned compositions according to the invention. Preferred dishwasher detergents or dishwasher detergent assistants according to the invention are thus characterized in that the water-soluble enclosure comprises a pouch made of water-soluble film and/or an injection-molded section and/or a blow-molded section and/or a deep-drawn section.

According to the invention, it is preferred for one or more enclosure(s) to be sealed. This brings the advantage that the dishwasher detergents are optimally protected against environmental influences, in particular against moisture. In addition, by virtue of these sealed enclosures, it is possible to further develop the invention inasmuch as the detergents comprise at least one gas to protect the contents of the enclosure(s) against moisture, see below.

Suitable materials for the completely or partially water-soluble enclosure are in principle all materials which are completely or partially soluble in aqueous phase under the given conditions of a washing operation, rinsing operation or cleaning operation (temperature, pH, concentration of washing-active components). The polymer materials may particularly preferably belong to the groups consisting of (optionally partially acetalized) polyvinyl alcohol, polyvinylpyrrolidone, polyethylene oxide, gelatin, cellulose and derivatives thereof, starch and derivatives thereof, in particular modified starches, and mixtures (polymer blends, composites, coextrudates etc.) of said materials. Particular preference is given to gelatin and polyvinyl alcohols, and said two materials in each case in a composite with starch or modified starch. Inorganic salts and mixtures thereof are also suitable materials for the at least partially water-soluble enclosure.

Preferred dishwasher detergents or dishwasher detergent assistants according to the invention are characterized in that the enclosure comprises one or more materials from the group consisting of acrylic acid-containing polymers, polyacrylamides, oxazoline polymers, polystyrenesulfonates, polyurethanes, polyesters and polyethers and mixtures thereof.

Particularly preferred dishwasher detergents or dishwasher detergent assistants according to the invention are characterized in that the enclosure comprises one or more water-soluble polymer(s), preferably a material from the group consisting of (optionally acetalized) polyvinyl alcohol (PVAL), polyvinylpyrrolidone, polyethylene oxide, gelatin, cellulose, and derivatives thereof and mixtures thereof, more preferably (optionally acetalized) polyvinyl alcohol (PVAL).

“Polyvinyl alcohols” (abbreviation PVAL, sometimes also PVOH) is here the name for polymers of the general structure 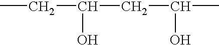
which also contain structural units of the type 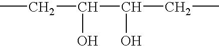
in small amounts (about 2%).

Standard commercial polyvinyl alcohols, which are supplied as white-yellowish powders or granules with degrees of polymerization in the range from about 100 to 2500 (molar masses from about 4000 to 100 000 g/mol), have degrees of hydrolysis of 98-99 or 87-89 mol % and thus also contain a residual content of acetyl groups. The polyvinyl alcohols are characterized on the part of the manufacturers by stating the degree of polymerization of the starting polymer, the degree of hydrolysis, the hydrolysis number and the solution viscosity.

Depending on the degree of hydrolysis, polyvinyl alcohols are soluble in water and less strongly polar organic solvents (formamide, dimethylformamide, dimethyl sulfoxide); they are not attacked by (chlorinated) hydrocarbons, esters, fats and oils. Polyvinyl alcohols are classified as being toxicologically acceptable and are at least partially biodegradable. The solubility in water can be reduced by after-treatment with aldehydes (acetalization), by complexation with Ni or Cu salts or by treatment with dichromates, boric acid or borax. The coatings made of polyvinyl alcohol are largely impenetrable to gases such as oxygen, nitrogen, helium, hydrogen, carbon dioxide, but allow water vapor to pass through.

For the purposes of the present invention, it is preferred that the enclosure comprises a polyvinyl alcohol whose degree of hydrolysis is 70 to 100 mol %, preferably 80 to 90 mol %, particularly preferably 81 to 89 mol % and in particular 82 to 88 mol %.

As materials for the enclosure, preference is given to using polyvinyl alcohols of a certain molecular weight range, it being preferred according to the invention for the enclosure to comprise a polyvinyl alcohol whose molecular weight is in the range from 10 000 to 100 000 gmol⁻¹, preferably from 11 000 to 90 000 gmol⁻¹, particularly preferably from 12 000 to 80 000 gmol⁻¹ and in particular from 13 000 to 70 000 gmol¹.

The degree of polymerization of such preferred polyvinyl alcohols is between approximately 200 to approximately 2100, preferably between approximately 220 to approximately 1890, particularly preferably between approximately 240 to approximately 1680 and in particular between approximately 260 to approximately 1500.

The polyvinyl alcohols described above are commercially available widely, for example under the trade name Mowiol® (Clariant). Polyvinyl alcohols which are particularly suitable within the scope of the present invention are, for example, Mowiol® 3-83, Mowiol® 4-88, Mowiol® 5-88 and Mowiol® 8-88.

Further polyvinyl alcohols which are particularly suitable as material for the hollow bodies are given in the table below:

| | Degree of | | |
|---|---|---|---|
| | hydrolysis | Molar mass | Melting |
| Name | [%] | [kDa] | point [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable as material for the hollow shape are ELVANOL® 51-05, 52-22, 50-42, 85-82, 75-15, T-25, T-66, 90-50 (trade name of Du Pont), ALCOTEX® 72.5, 78, B72, F80/40, F88/4, F88/26, F88/40, F88/47 (trade name of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade name of Nippon Gohsei K.K.).

The solubility of PVAL in water can be changed by after-treatment with aldehydes (acetalization) or ketones (ketalization). Polyvinyl alcohols which have proven to be particularly preferred and particularly advantageous due to their outstandingly good solubility in cold water are those which are acetalized or ketalized with the aldehyde or keto groups, respectively, of saccharides or polysaccharides .or mixtures thereof. It has proven especially advantageous to use the reaction products of PVAL and starch.

In addition, the solubility in water can be changed by complexation with Ni or Cu salts or by treatment with dichromates, boric acid, borax and thus be adjusted to desired values in a targeted manner. Films made of PVAL are largely impenetrable to gases such as oxygen, nitrogen, helium, hydrogen, carbon dioxide, but allow water vapor to pass through.

Examples of suitable water-soluble PVAL films are the PVAL films obtainable under the name “SOLUBLON®” from Syntana Handelsgesellschaft E. Harke GmbH & Co. Their solubility in water can be adjusted to a precise degree and films of this product series are available which are soluble in the aqueous phase in all temperature ranges relevant for the application.

Polyvinylpyrrolidones, shortened to PVPs, can be described by the following general formula: 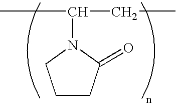
PVPs are prepared by free-radical polymerization of 1-vinylpyrrolidone. Standard commercial PVPs have molar masses in the range from about 2500 to 750 000 g/mol and are supplied as white, hygroscopic powders or as aqueous solutions.

Polyethylene oxides, shortened to PEOXs, are polyalkylene glycols of the general formula
H—[O—CH₂—CH_{2 —OH}
which are prepared industrially by base-catalyzed polyaddition of ethylene oxide (oxirane) in systems comprising mostly small amounts of water with ethylene glycol as starter molecule. They have molar masses in the range from about 200 to 5 000 000 g/mol, corresponding to degrees of polymerization n of from about 5 to >100 000. Polyethylene oxides have an extremely low concentration of reactive hydroxy end groups and exhibit only weak glycol properties.

Gelatin is a polypeptide (molar mass: about 15 000 to >250 000 g/mol) which is obtained primarily by hydrolysis of the collagen present in animal skin and bones under acidic or alkaline conditions. The amino acid composition of the gelatin largely corresponds to that of the collagen from which it has been obtained and varies depending on its provenance. The use of gelatin as water-soluble shell material is extremely widespread in particular in pharmacy in the form of hard or soft gelatin capsules. Gelatin is not used widely in the form of films due to its high cost relative to the polymers specified above.

Within the scope of the present invention, preference is also given to dishwasher detergents whose packaging consists at least partially of water-soluble film of at least one polymer from the group consisting of starch and starch derivatives, cellulose and cellulose derivatives, in particular methylcellulose and mixtures thereof.

Starch is a homoglycan, where the glucose units are α-glycosidically joined. Starch is made up of two components of different molecular weight: from about 20 to 30% of straight-chain amylose (MW about 50 000 to 150 000) and 70 to 80% of branched-chain amylopectin (MW about 300 000 to 2 000 000). In addition, small amounts of lipids, phosphoric acid and cations are also present. Whereas the amylose forms long, helical, intertwined chains with about 300 to 1200 glucose molecules as a result of the bond in the 1,4 position, the chain in the case of amylopectin branches after on average 25 glucose building blocks by a 1,6 bond to a branch-like structure with about 1500 to 12 000 molecules of glucose. As well as pure starch, starch derivatives which are obtainable from starch by polymer-analogous reactions are also suitable for the preparation of water-soluble enclosures for the washing composition, rinse composition and cleaning composition portions within the scope of the present invention. Such chemically modified starches include, for example, compositions from esterifications or etherifications in which hydroxy hydrogen atoms have been substituted. However, starches in which the hydroxy groups have been replaced by functional groups which are not bonded via an oxygen atom can also be used as starch derivatives. The group of starch derivatives includes, for example, alkali metal starches, carboxymethylstarch (CMS), starch esters and starch ethers, and aminostarches.

Pure cellulose has the formal gross composition (C₆H₁₀O₅)ₙ and, considered formally, is a β-1,4-polyacetal of cellobiose which, for its part, is constructed from two molecules of glucose. Suitable celluloses consist of about 500 to 5000 glucose units and, accordingly, have average molar masses of from 50 000 to 500 000. Cellulose-based disintegrants which can be used within the scope of the present invention are also cellulose derivatives which are obtainable from cellulose by polymer-analogous reactions. Such chemically modified celluloses include, for example, compositions of esterifications and etherifications in which hydroxyl hydrogen atoms have been substituted. However, celluloses in which the hydroxy groups have been replaced by functional groups not attached via an oxygen atom may also be used as cellulose derivatives. The group of cellulose derivatives includes, for example, alkali metal celluloses, carboxymethylcellulose (CMC), cellulose esters and ethers, and aminocelluloses.

Preferred enclosures of at least partially water-soluble film comprise at least one polymer with a molar mass between 5000 and 500 000 g/mol, preferably between 7500 and 250 000 g/mol and in particular between 10 000 and 100 000 g/mol. The enclosure has different material thicknesses depending on the production process, preference being given to dishwasher detergents or dishwasher detergent assistants according to the invention in which the wall thickness of the enclosure is 10 to 5000 μm, preferably 20 to 3000 μm, particularly preferably, 25 to 2000 μm and in particular 100 to 1500 μm.

If film pouches are chosen as packaging, then the water-soluble film which forms the enclosure preferably has a thickness of from 1 to 300 μm, preferably from 2 to 200 μm, particularly preferably from 5 to 150 μm and in particular from 10 to 100 μm.

These water-soluble films can be produced by various production processes. In principle, blowing, calendering and casting processes should be mentioned. In a preferred process, the films are blown starting from a melt using air by means of a blowing mandrel to give a hose. In the calendering process, which is likewise a type of preferred production process, the raw materials plasticized by suitable additives are atomized to form the films. It may in particular be necessary here to follow the atomization with a drying step. In the casting process, which is likewise a type of preferred production process, an aqueous polymer preparation is placed onto a heatable drying roll, is optionally cooled following evaporation of the water and the film is removed in the form of a sheet. Where necessary, this sheet is additionally powdered before being removed or whilst being removed.

According to the invention, preference is given to an embodiment according to which the enclosure is water-soluble as a whole, i.e. dissolves completely when used in accordance with directions during machine washing if the conditions envisaged for dissolution are achieved.

Particularly preferred completely water-soluble enclosures are e.g. capsules made of gelatin, advantageously made of soft gelatin, or pouches made of (optionally partially acetalized) PVAL or spheres of gelatin or (optionally partially acetalized) PVAL or of one or more organic and/or inorganic salts, preferably spheres of soft gelatin. An essential advantage of this embodiment is that the enclosure must at least partially dissolve within a practically relevant short time—as a nonlimiting example a few seconds to 5 min can be specified under exactly defined conditions in the cleaning liquor and thus, in accordance with the requirements, introduce the surrounded content, i.e. the cleaning-active material or two or more materials, into the liquor.

In another embodiment of the invention, which is likewise preferred on the basis of advantageous properties, the water-soluble enclosure includes sections which are less readily soluble or even insoluble in water or are soluble in water only at elevated temperature, and sections which are readily water-soluble or water-soluble at a low temperature. In other words, the enclosure consists not only of one uniform material having the same solubility in water in all areas, but of materials of differing solubility in water. In this connection, a distinction is to be made between areas of good solubility on the one hand and areas with less good solubility in water, with poor or even no solubility in water or areas in which the solubility in water achieves the desired value only at elevated temperature or only at a different pH or only at a changed electrolyte concentration. This may lead, when using the product in accordance with the directions under adjustable conditions, to certain areas of the enclosure dissolving, while other areas remain intact. An enclosure provided with pores or holes thus forms into which water and/or liquor can penetrate, dissolve washing-active, rinse-active or cleaning-active ingredients and flush them out of the enclosure. In the same way, enclosure systems in the form of multichamber pouches or in the form of hollow bodies arranged inside one another (e.g. spheres: “onion system”) can also be provided. In this way, systems with controlled release of the washing-active, rinse-active or cleaning-active ingredients can be prepared.

For the formation of such systems, the invention is not subject to limitations. For example, enclosures can be provided in which a uniform polymer material includes small areas of incorporated compounds (for example of salts) which are more rapidly soluble in water than the polymer material. On the other hand, two or more polymer materials with different solubility in water can also be mixed (polymer blend), so that the polymer material which dissolves more quickly is more rapidly disintegrated under defined conditions by water or the liquor than the material which dissolves more slowly.

It corresponds to a particularly preferred embodiment of the invention that the areas of the enclosure which are less readily soluble in water or areas which are completely insoluble in water or areas which are soluble in water only at elevated temperature are areas made of a material which essentially corresponds chemically to that of the readily water-soluble areas or areas which are water-soluble at a lower temperature, but has a higher layer thickness and/or has a changed degree of polymerization of the same polymer and/or has a higher degree of crosslinking of the same polymer structure and/or has a higher degree of acetalization (in the case of PVAL, for example with saccharides, polysaccharides, such as starch) and/or has a content of water-insoluble salt components and/or has a content of a water-insoluble polymer. Even taking into consideration the fact that the enclosure does not dissolve completely, cleaning composition portions according to the invention can be prepared which have advantageous properties upon release of the dishwasher detergent into the particular liquor.

The water-soluble shell material is preferably transparent. For the purposes of this invention, transparency is understood as meaning that the transmittance within the visible spectrum of light (410 to 800 nm) is greater than 20%, preferably greater than 30%, most preferably greater than 40% and especially greater than 50%. Thus, as soon as a wavelength of the visible spectrum of light has a transmittance greater than 20%, it can be considered to be transparent within the scope of the invention.

Dishwasher detergents according to the invention which are packaged in transparent enclosures or containers may comprise a stabilizer as an essential constituent. For the purposes of the invention, stabilizers are materials which protect the detergent constituents in their water-soluble, transparent enclosures against decomposition or deactivation as a result of light irradiation. Antioxidants, UV absorbers and fluorescent dyes have proven particularly suitable.

For the purposes of the invention, particularly suitable stabilizers are the antioxidants. In order to prevent undesired changes to the formulations caused by light irradiation and thus free-radical decomposition, the formulations may comprise antioxidants. Antioxidants which may be used here are, for example, phenols, bisphenols and thiobisphenols substituted by sterically hindered groups. Further examples are propyl gallate, butylhydroxytoluene (BHT), butylhydroxyanisole (BHA), t-butylhydroquinone (TBHQ), tocopherol and the long-chain (C8-C22) esters of gallic acid, such as dodecyl gallate. Other classes of substance are aromatic amines, preferably secondary aromatic amines and substituted p-phenylenediamines, phosphorus compounds with trivalent phosphorus, such as phosphines, phosphites and phosphonites, citric acids and citric acid derivatives, such as isopropyl citrate, compounds containing enediol groups, so-called reductones, such as ascorbic acid and its derivatives, such as ascorbic acid palmitate, organosulfur compounds, such as the esters of 3,3′-thiodipropionic acid with C₁₋₁₈-alkanols, in particular C₁₀₋₁₈-alkanols, metal ion deactivators which are able to complex the autooxidation-catalyzing metal ions, such as, for example, copper, such as nitrilotriacetic acid and modifications thereof and admixtures. Antioxidants may be present in the formulations in amounts up to 35% by weight, preferably up to 25% by weight, particularly preferably from 0.01 to 20% by weight and in particular from 0.03 to 20% by weight.

A further class of stabilizers which can preferably be used are the UV absorbers. UV absorbers are able to improve the resistance of the formulation constituents to light. They are understood as meaning organic substances (light protection filters) which are able to absorb ultraviolet rays and emit the absorbed energy again in the form of long-wave radiation, e.g. heat. Compounds which have these desired properties are, for example, the compounds and derivatives of benzophenone with substituents in the 2 and/or 4 position which are effective as a result of radiation-free deactivation. Also suitable are, furthermore, substituted benzotriazoles, such as, for example, the water-soluble benzenesulfonic acid 3-(2H-benzotriazol-2-yl) -4-hydroxy-5-(methylpropyl)monosodium salt (Cibafast® R), acrylates which are substituted by phenyl in the 3 position (cinnamic acid derivatives), optionally by cyano groups in the 2 position, salicylates, organic Ni complexes and natural substances such as umbelliferone and endogenous urocanic acid. Biphenyl and, in particular, stilbene derivatives are of particular importance; these are available commercially as Tinosorb® FD or Tinosorb® FR ex Ciba. Examples of UV-B-absorbers are 3-benzylidenecamphor or 3-benzylidenenorcamphor and derivatives thereof, e.g. 3-(4-methylbenzylidene) camphor; 4-aminobenzoic acid derivatives, preferably 2-ethylhexyl 4-(dimethyl-amino) benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, such as, for example, 2,4,6-trianilino(p-carbo-2′-ethyl-1′-hexyloxy)-1,3,5-triazine and octyl triazone or dioctylbutamidotriazone (Uvasorb® HEB); propane-1,3-diones, such as, for example, 1-(4-tert-butylphenyl)-3-(4′-methoxyphenyl)propane-1,3-dione; ketotricyclo(5.2.1.0)decane derivatives. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, such as, for example, 4-(2-oxo-3-bornylidenemethyl)-benzenesulfonic acid and 2-methyl-5-(2-oxo-3-bornylidene)sulfonic acid and salts thereof.

Suitable typical UV-A filters are, in particular, derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds. The UV-A and UV-B filters can of course also be used in mixtures. As well as said soluble substances, insoluble light protection pigments are also suitable for this purpose, namely finely dispersed, preferably nanoized, metal oxides or salts. Examples of suitable metal oxides are, in particular, zinc oxide and titanium dioxide and also oxides of iron, zirconium, silicon, manganese, aluminum and cerium, and mixtures thereof. Salts which may be used are silicates (talc), barium sulfate or zinc stearate. The oxides and salts are already used in the form of pigments for skin care and skin-protecting emulsions and decorative cosmetics. The particles should here have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, such as, for example, titanium dioxide T 805 (Degussa) or Eusolex® T2000 (Merck). Suitable hydrophobic coating agents here are primarily silicones and, particularly preferably, trialkoxyoctylsilanes or simethicones. Preference is given to using micronized zinc oxide.

UV absorbers may be present in the dishwasher detergents in amounts up to 5% by weight, preferably up to 3% by weight, particularly preferably from 0.01 to 2.0% by weight and in particular from 0.03 to 1% by weight.

A further class of stabilizers which can preferably be used are the fluorescent dyes. These include the 4,4′-diamino-2,2′-stilbenedisulfonic acids (flavone acids), 4,4′-distyrylbiphenyls, methylumbelliferones, coumarins, dihydroquinolinones, 1,3-diarylpyrazolines, naphthalimides, benzoxazole, benzisooxazole and benzimidazole systems, and pyrene derivatives substituted by heterocycles. Of particular importance in this connection are the sulfonic acid salts of diaminostilbene derivatives, and polymeric fluorescent substances, as disclosed in U.S. Pat. No. 5,082,578.

Fluorescent substances may be present in the formulations in amounts up to 5% by weight, preferably up to 1% by weight, particularly preferably from 0.01 to 0.5% by weight and in particular from 0.03 to 0.1% by weight.

In a preferred embodiment, the abovementioned stabilizers are used in any desired mixtures. The stabilizers are used in amounts up to 40% by weight, preferably up to 30% by weight, particularly preferably from 0.01 to 20% by weight, in particular from 0.02 to 5% by weight.

Preferred dishwasher detergents or dishwasher detergent assistants comprise, independently of the way in which they are formulated, at least one washing-active or cleaning-active substance from the group of bleaches, bleach activators, polymers, builders, surfactants, enzymes, electrolytes, pH regulators, fragrances, perfume carriers, dyes, hydrotropic agents, foam inhibitors, antimicrobial active ingredients, germicides, fungicides, corrosion inhibitors, non-aqueous solvents. These substances shall be described in more detail below.

Builders

According to the present invention, all builders customarily used in dishwasher detergents or dishwasher detergent assistants can be incorporated into the washing and cleaning detergents and cleaners, in particular silicates, carbonates, organic cobuilders and also the phosphates.

Suitable crystalline, layered sodium silicates have the general formula NaMSiₓO₂ₓ₊₁.H₂O, where M is sodium or hydrogen, x is a number from 1.9 to 4 and y is a number from 0 to 20, and preferred values for x are 2, 3 or 4. Preferred crystalline phyllosilicates of the given formula are those in which M is sodium and x assumes the values 2 or 3. In particular, both β- and also δ-sodium disilicates Na₂Si₂O₅.yH₂O are preferred.

It is also possible to use amorphous sodium silicates with an Na₂O:SiO₂ modulus of from 1:2 to 1:3.3, preferably from 1:2 to 1:2.8 and in particular from 1:2 to 1:2.6, which have delayed dissolution and secondary detergency properties. The dissolution delay relative to conventional amorphous sodium silicates can have been induced in various ways, for example by surface treatment, compounding, compaction/compression or by overdrying. Within the scope of this invention, the term “amorphous” is also understood as meaning “X-ray-amorphous”. This means that in X-ray diffraction experiments, the silicates do not give sharp X-ray reflections typical of crystalline substances, but, at best, one or more maxima of the scattered X-ray radiation, which have a width of several degree units of the angle of diffraction. However, it is very possible that particularly good builder properties may result if, in electron diffraction experiments, the silicate particles give poorly defined or even sharp diffraction maxima. This is to be interpreted to the effect that the products have microcrystalline regions of size 10 to a few hundred nm, values up to a maximum of 50 nm and in particular up to a maximum of 20 nm being preferred. Particular preference is given to the compressed/compacted amorphous silicates, compounded amorphous silicates and overdried X-ray-amorphous silicates.

Carbonates which may be present in the compositions are either the monoalkali metal salts or the dialkali metal salts of carbonic acid, or else sesquicarbonates. Preferred alkali metal ions are sodium and/or potassium ions. In one embodiment, it may be preferred to mix in the carbonate and/or bicarbonate separately or subsequently at least partially as a further component. Compounds of, for example, carbonate, silicate and optionally further auxiliaries, such as, for example, anionic surfactants or other, in particular organic, builder substances, may also be present as a separate component in the finished compositions.

It is of course also possible to use the generally known phosphates as builder substances, provided such a use should not be avoided for ecological reasons. Of the large number of commercially available phosphates, the alkali metal phosphates, particularly preferably pentasodium or pentapotassium triphosphate (sodium or potassium tripolyphosphate), are of the greatest importance in the detergents and cleaners industry.

Alkali metal phosphates is the collective term for the alkali metal (in particular sodium and potassium) salts of the various phosphoric acids, among which metaphosphoric acids (HPO₃)ₙ and orthophosphoric acid H₃PO₄, in addition to higher molecular weight representatives, may be differentiated. The phosphates combine a number of advantages: they act as alkali carriers, prevent limescale film on machine components or limescale deposits on the ware and additionally contribute to the cleaning performance.

Suitable phosphates are sodium dihydrogenphosphate, NaH₂PO₄, disodium hydrogenphosphate (secondary sodium phosphate), Na₂HPO₄, trisodium phosphate, tertiary sodium phosphate, Na₃PO₄, tetrasodium diphosphate (sodium pyrophosphate), Na₄P₂O₇, the high molecular weight sodium and potassium phosphates formed by condensation of NaH₂PO₄ or of KH₂PO₄, with which a distinction can be made between cyclic representatives, the sodium or potassium metaphosphates, and chain-like types, the sodium or potassium polyphosphates, and also pentasodium triphosphate, Na₅P₃O₁₀ (sodium tripolyphosphate)

Apart from the sodium phosphates specified, the corresponding potassium salts or mixtures of both of these can be used; it is also possible to use mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate according to the invention.

Dishwasher detergents or dishwasher detergent assistants preferred for the purposes of the present invention do not comprise sodium hydroxide and/or potassium hydroxide.

Preferred water-soluble builders are, for example, tripotassium citrate and the potassium waterglasses.

Preferred dishwasher detergents or dishwasher detergent assistants comprise 20 to 60% by weight of one or more water-soluble builders, preferably citrates and/or phosphates, preferably alkali metal phosphates, particularly preferably the pentasodium and pentapotassium triphosphate (sodium and potassium tripolyphosphate).

In preferred embodiments of the present invention, the content of water-soluble builders in the compositions is within relatively narrow limits. In this regard, preference is given to dishwasher detergents or dishwasher detergent assistants which comprise the water-soluble builder(s) in amounts of from 22.5 to 55% by weight, preferably from 25 to 50% by weight and in particular from 27.5 to 45% by weight, in each case based on the total composition.

The compositions according to the invention can particularly advantageously comprise condensed phosphates as water-softening substances. These substances form a group of phosphates—due to their preparation also called fused or high-temperature phosphates—which can be derived from acidic salts of orthophosphoric acid (phosphoric acids) by condensation. The condensed phosphates can be divided into the metaphosphates [M^{I}n(PO₃)ₙ] and polyphosphates (M^{I}_{n°2}PₙO₃ₙ₊₁ or M^{I}ₙH₂PₙO₃ₙ₊₁).

The term “metaphosphates” was originally the general name for condensed phosphates with the composition Mₙ[PₙO₃ₙ] (M=monovalent metal), but is nowadays mostly restricted to salts with ring-shaped cyclo(poly)phosphate anions. When n=3, 4, 5, 6 etc. the names are tri-, tetra-, penta-, hexametaphosphates, etc. According to the systematic nomenclature of the isopolyanions, the anion where n=3 is, for example, referred to as cyclotriphosphate.

Metaphosphates are obtained as accompanying substances of the Graham salt—incorrectly referred to as sodium hexametaphosphate—by melting NaH₂PO₄ at temperatures exceeding 620° C., where so-called Maddrell's salt is also formed as an intermediate. This salt and Kurrol's salt are linear polyphosphates which are mostly nowadays not included with the metaphosphates, but which can likewise be used advantageously as water-softening substances for the purposes of the present invention.

The crystalline, water-insoluble Maddrell's salt, (NaPO₃)ₓ, where x is >1000, which can be obtained at 200-300° C. from NaH₂PO₄, converts, at about 600° C., into the cyclic metaphosphate [Na₃(PO₃)₃], which melts at 620° C. The quenched, glass-like melt is, depending on the reaction conditions, the water-soluble Graham's salt (NaPO₃)_{40- 50}, or a glass-like condensed phosphate of the composition (NaPO₃)₁₅₋₂₀, which is known as Calgon. For both compositions, the erroneous name hexametaphosphates is still in use. The so-called Kurrol's salt, (NaPO₃)ₙ, where n is >>5000, likewise arises from the 600° C.-hot melt of the Maddrell's salt if this is left for a short time at about 500° C. It forms highly polymeric water-soluble fibers.

The “hexametaphosphates” Budit® H6 and H8 from Budenheim have proven particularly preferred water-softening substances from the classes of condensed phosphates specified above.

Particularly preferred within the scope of the present application are dishwasher detergents or dishwasher detergent assistants which additionally comprise one or more substances from the group of acidifying agents, chelate complexing agents or of film-inhibiting polymers.

Possible acidifiers are either inorganic acids or organic acids provided these are compatible with the other ingredients. For reasons of consumer protection and handling safety, the solid mono-, oligo- and polycarboxylic acids in particular can be used. From this group, preference is in turn given to citric acid, tartaric acid, succinic acid, malonic acid, adipic acid, maleic acid, fumaric acid, oxalic acid, and polyacrylic acid. The anhydrides of these acids can also be used as acidifiers, maleic anhydride and succinic anhydride in particular being commercially available. Organic sulfonic acids, such as amidosulfonic acid can likewise be used. A composition which is commercially available and which can likewise preferably be used as acidifier for the purposes of the present invention is Sokalan® DCS (trademark of BASF), a mixture of succinic acid (max. 31% by weight), glutaric acid (max. 50% by weight) and adipic acid (max. 33% by weight).

A further possible group of ingredients are the chelate complexing agents. Chelate complexing agents are substances which form cyclic compounds with metal ions, where a single ligand occupies more than one coordination site on a central atom, i.e. is at least “bidentate”. In this case, stretched compounds are thus normally closed by complex formation via an ion to give rings. The number of bonded ligands depends on the coordination number of the central ion.

Chelate complexing agents which are customary and preferred for the purposes of the present invention are, for example, polyoxycarboxylic acids, polyamines, ethylenediaminetetraacetic acid (EDTA) and nitrilotriacetic acid (NTA). Complex-forming polymers, i.e. polymers which carry functional groups either in the main chain itself or laterally relative to this, which can act as ligands and react with suitable metal atoms usually to form chelate complexes, can also be used according to the invention. The polymer-bonded ligands of the resulting metal complexes can originate from just one macromolecule or else belong to different polymer chains. The latter leads to crosslinking of the material, provided the complex-forming polymers have not already been crosslinked beforehand via covalent bonds.

Complexing groups (ligands) of customary complex-forming polymers are iminodiacetic acid, hydroxyquinoline, thiourea, guanidine, dithiocarbamate, hydroxamic acid, amidoxime, aminophosphoric acid, (cycl.) polyamino, mercapto, 1,3-dicarbonyl and crown ether radicals, some of which have very specific activities toward ions of different metals. Basis polymers of many complex-forming polymers, which are also commercially important, are polystyrene, polyacrylates, polyacrylonitriles, polyvinyl alcohols, polyvinylpyridines and polyethylenimines. Natural polymers, such as cellulose, starch or chitin are also complex-forming polymers. Moreover, these may be provided with further ligand functionalities as a result of polymer-analogous modifications.

For the purposes of the present invention, particular preference is given to dishwasher detergents or dishwasher detergent assistants which comprise one or more chelate complexing agents from the groups of
(i) polycarboxylic acids in which the sum of the carboxyl and optionally hydroxyl groups is at least 5,
(ii) nitrogen-containing mono- or polycarboxylic acids,
(iii) geminal diphosphonic acids,
(iv) aminophosphonic acids,
(v) phosphonopolycarboxylic acids,
(vi) cyclodextrins
   in amounts above 0.1% by weight, preferably above 0.5% by weight, particularly preferably above 1% by weight and in particular above 2.5% by weight, in each case based on the weight of the dishwasher composition.

For the purposes of the present invention, it is possible to use all complexing agents of the prior art. These may belong to different chemical groups. Preference is given to using the following, individually or -in a mixture with one another:
a) polycarboxylic acids in which the sum of the carboxyl and optionally hydroxyl groups is at least 5, such as gluconic acid,
b) nitrogen-containing mono- or polycarboxylic acids, such as ethylenediaminetetraacetic acid (EDTA), N-hydroxyethylethylenediaminetriacetic acid, diethylenetriaminepentaacetic acid, hydroxyethyliminodiacetic acid, nitridodiacetic acid-3-propionic acid, isoserinediacetic acid, N,N-di(p-hydroxyethyl)glycine, N-(1,2-dicarboxy-2-hydroxyethyl)glycine, N-(1,2-dicarboxy-2-hydroxyethyl)-aspartic acid or nitrilotriacetic acid (NTA),
c) geminal diphosphonic acids, such as 1-hydroxyethane-1,1-diphosphonic acid (HEDP), higher homologs thereof having up to 8 carbon atoms, and hydroxy or amino group-containing derivatives thereof and 1-aminoethane-1,1-diphosphonic acid, higher homologs thereof having up to 8 carbon atoms, and hydroxy or amino group-containing derivatives thereof,
d) aminophosphonic acids, such as ethylenediaminetetra(methylenephosphonic acid), diethylenetriaminepenta(methylenephosphonic acid) or nitrilotri(methylenephosphonic acid),
e) phosphonopolycarboxylic acids, such as 2-phosphonobutane-1,2,4-tricarboxylic acid, and
f) cyclodextrins.

For the purposes of this patent application, polycarboxylic acids a) are understood as meaning carboxylic acids—including monocarboxylic acids—in which the sum of carboxyl and the hydroxyl groups present in the molecule is at least 5. Complexing agents from the group of nitrogen-containing polycarboxylic acids, in particular EDTA, are preferred. At the alkaline pH values of the treatment solutions required according to the invention, these complexing agents are at least partially in the form of anions. It is unimportant whether they are introduced in the form of acids or in the form of salts. In the case of using salts, alkali metal, ammonium or alkylammonium salts, in particular sodium salts, are preferred.

Film-inhibiting polymers may likewise be present in the compositions according to the invention. These substances, which may have chemically different structures, originate, for example, from the groups of low molecular weight polyacrylates with molar masses between 1000 and 20 000 daltons, preference being given to polymers with molar masses below 15 000 daltons.

Film-inhibiting polymers may also have cobuilder properties. Organic cobuilders which may be used in the dishwasher detergents according to the invention are, in particular, polycarboxylates/polycarboxylic acids, polymeric polycarboxylates, aspartic acid, polyacetals, dextrins, further organic cobuilders (see below) and phosphonates. These classes of substance are described below.

Organic builder substances which can be used are, for example, the polycarboxylic acids usable in the form of their sodium salts, the term polycarboxylic acids meaning carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), provided such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids per se may also be used. In addition to their builder action, the acids typically also have the property of an acidifying component and thus also serve to establish a lower and milder pH of detergents or cleaners. In this connection, particular mention is made of citric acid, succinic acid, glutaric acid, adipic acid, gluconic acid and any mixtures thereof.

Also suitable as builders or film inhibitors are polymeric polycarboxylates; these are, for example, the alkali metal salts of polyacrylic acid or of polymethacrylic acid, for example those having a relative molecular mass of from 500 to 70 000 g/mol.

The molar masses given for polymeric polycarboxylates are, for the purposes of this specification, weight-average molar masses Mw of the respective acid form, determined fundamentally by means of gel permeation chromatography (GPC) using a UV detector. The measurement was made against an external polyacrylic acid standard which, owing to its structural similarity to the polymers under investigation, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Organic cobuilders which may be used in the detergents within the scope of the present invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which can be used are, for example, the polycarboxylic acids usable in the form of their sodium salts, the term polycarboxylic acids meaning carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), provided such a use is not objectionable on ecological grounds, and mixtures thereof. Preferred salts are the salts of the polycarboxylic acids such as citric acid, adipic acid, succinic acid, glutaric acid, tartaric acid, methylglycinediacetic acid, sugar acids and mixtures thereof.

The acids per se may also be used. In addition to their builder action, the acids typically also have the property of an acidifying component and thus also serve to establish a lower and milder pH of detergents or cleaners. In this connection, particular mention is made of citric acid, succinic acid, glutaric acid, adipic acid, gluconic acid and any mixtures thereof.

Also suitable as builders are polymeric polycarboxylates; these- are, for example, the alkali metal salts of polyacrylic acid or of polymethacrylic acid, for example those with a relative molecular mass from 500 to 70 000 g/mol.

The molar masses given for polymeric carboxylates are, within the scope of this specification, weight-average molar masses Mw of the respective acid, which have been determined fundamentally by means of gel permeation chromatography (GPC) using a UV detector. The measurement was made against an external polyacrylic acid standard which, owing to its structural similarity to the polymers under investigation, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Suitable polymers are, in particular, polyacrylates which preferably have a molecular mass of from 1000 to 20 000 g/mol. Owing to their superior solubility, preference in this group may be given in turn to the short-chain polyacrylates which have molar masses of from 1000 to 10 000 g/mol and particularly preferably from 1200 to 4000 g/mol.

In the compositions according to the invention, particular preference is given to using either polyacrylates or copolymers of unsaturated carboxylic acids, monomers containing sulfonic acid groups, and optionally further ionic or nonionogenic monomers. The copolymers containing sulfonic acid groups are described in detail below.

However, it is also possible to provide products according to the invention which, being so-called “3 in 1” products, combine the conventional detergent, rinse aid and a salt replacement function. In this regard preference is given to dishwasher detergents according to the invention which additionally comprise 0.1 to 70% by weight of copolymers of
i) unsaturated carboxylic acids,
ii) monomers containing sulfonic acid groups
iii) optionally further ionic or nonionogenic monomers.

These copolymers lead to the parts of dishes treated with such compositions becoming significantly cleaner in subsequent washing operations than parts of dishes which were rinsed with conventional compositions.

An additional positive effect is the shortening of the drying time of the parts of dishes treated with the detergent, i.e. the consumer can take the dishes from the machine earlier and reuse them after the wash program is finished.

For the purposes of the present invention, unsaturated carboxylic acids of the formula VII are preferred as monomer,
R¹(R²)C═C(R³)COOH (VII),
in which R¹ to R³, independently of one another, are —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms.

Among the unsaturated carboxylic acids which can be described by the formula VII, particular preference is given to acrylic acid (R¹═R²═R³═H), methacrylic acid (R¹═R²═H; R³═CH₃) and/or maleic acid (R¹═COOH; R²═R³═H).

In the case of the monomers containing sulfonic acid groups, preference is given to those of the formula VIII,
R⁵(R⁶)C═C(R⁷)—X—SO₃H (VIII),
in which R⁵ to R⁷, independently of one another, are —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms, and X is an optionally present spacer group which is chosen from —(CH₂)ₙ—, where n=0 to 4, —COO—(CH₂)ₖ— where k=1 to 6, —C(O)—NH—C(CH₃)₂— and —C(O)—NH— CH(CH₂CH₃)—.

Among these monomers, preference is given to those of the formulae VIIIa, VIIIb and/or VIIIc,
H₂C═CH—X—SO₃H (VIIIa),
H₂C═C (CH₃)—X—SO₃H (VIIIb),
HO₃S—X—(R⁶)C═C(R⁷)—X—SO3H (VIIIc),
in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)ₙ—, where n=0 to 4, —COO—(CH₂)ₖ— where k=1 to 6, —C(O)—NH—C(CH₃)₂— and —C(O)—NH—CH (CH₂CH₃)—.

Particularly preferred monomers containing sulfonic acid groups here are 1-acrylamido-1-propanesulfonic acid (X═—C(O)NH—CH(CH₂CH₃) in formula IIa), 2-acrylamido-2-propanesulfonic acid (X═—C(O)NH—C(CH₃)₂ in formula VIIIa), 2-acrylamido-2-methyl-1-propanesulfonic acid (X═—C(O)NH—CH(CH₃)CH₂— in formula VIIIa), 2-methacrylamido-2-methyl-1-propanesulfonic acid (X═—C(O)NH—CH(CH₃)CH₂— in formula VIIIb), 3-methacrylamido-2-hydroxypropanesulfonic acid (X═—C(O)NH—CH₂CH(OH)CH₂— in formula VIIIb), allylsulfonic acid (X═CH₂ in formula VIIIa), methallylsulfonic acid (X═CH₂ in formula IIb), allyloxybenzenesulfonic acid (X═—CH₂—O—C₆H₄— in formula VIIIa), methallyloxybenzenesulfonic acid (X═—CH₂—O—C₆H₄— in formula VIIIb), 2-hydroxy-3-(2-propenyloxy)propanesulfonic acid, 2-methyl-2-propene-1-sulfonic acid (X═CH₂ in formula VIIIb), styrenesulfonic acid (X═C₆H₄ in formula VIIIa), vinylsulfonic acid (X not present in formula VIIIa), 3-sulfopropyl acrylate (X═—C(O)NH—CH₂CH₂CH₂— in formula VIIIa), 3-sulfopropyl methacrylate (X═—C(O)NH—CH₂CH₂CH₂— in formula VIIIb), sulfomethacrylamide (X═—C(O)NH— in formula VIIIb), sulfomethyl methacrylamide (X═—C(O)NH—CH₂— in formula VIIIb) and water-soluble salts of said acids.

Suitable further ionic or nonionogenic monomers are, in particular, ethylenically unsaturated compounds. Preferably the content of the monomers of group iii) in the polymers used according to the invention is less than 20% by weight, based on the polymer. Polymers to be used with particular preference consist merely of monomers of groups i) and ii).

In summary, copolymers of

i) unsaturated carboxylic acids of the formula VII
R¹(R²)C═C(R³)COOH (VII),
in which R¹ to R³, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms,
ii) monomers of the formula VIII containing sulfonic acid groups
R⁵(R⁶)C═C(R⁷)—X—SO₃H (VIII),
in which R⁵ to R⁷, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms, and X is an optionally present spacer group which is chosen from —(CH₂)ₙ—, where n=0 to 4, —COO—(CH₂)ₖ— where k=1 to 6, —C(O)—NH—C(CH₃)₂— and —C(O)—NH—CH(CH₂CH₃)—
iii) optionally further ionic or nonionogenic monomers are particularly preferred.

Particularly preferred copolymers consist of

i) one or more unsaturated carboxylic acids from the group consisting of acrylic acid, methacrylic acid and/or maleic acid

ii) one or more monomers containing sulfonic acid groups and of the formulae VIIIa, VIIIb and/or VIIIc:
H₂C═CH—X—SO₃H (VIIIa),
H₂C═C(CH₃)—X—SO₃H (VIIIb),
HO₃S—X—(R⁶)C═C(R⁷)—X—SO₃H (VIIIc),
in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)ₙ—, where n=0 to 4, —COO—(CH₂)ₖ—, where k=1 to 6, —C(O)—NH—C(CH₃)₂— and —C(O)—NH—CH(CH₂CH₃)—
iii) optionally further ionic or nonionogenic monomers.

The copolymers present in the products can comprise the monomers from groups i) and ii), and optionally iii) in varying amounts, where all of the representatives from group i) can be combined with all of the representatives from group ii) and all of the representatives from group iii). Particularly preferred polymers have certain structural units which are described below.

Thus, for example, preference is given to products according to the invention which are characterized in that they comprise one or more copolymers which contain structural units of the formula IX
—[CH₂—CHCOOH]ₘ[CH₂—CHC(O)—Y—SO₃H ]ₚ— (IX),
in which m and p are in each case a whole natural number between 1 and 2000, and Y is a spacer group chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

These polymers are prepared by copolymerization of acrylic acid with an acrylic acid derivative containing sulfonic acid groups. Copolymerizing the acrylic acid derivative containing sulfonic acid groups with methacrylic acid leads to another polymer which is likewise used with preference in the products according to the invention and is characterized in that the products comprise one or more copolymers which contain structural units of the formula X
—[CH₂—C(CH₃)COOH]ₘ[CH₂—CHC(O)—Y—SO₃H]ₚ— (X),
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

Entirely analogously, acrylic acid and/or methacrylic acid can also be copolymerized with methacrylic acid derivatives containing sulfonic acid groups, as a result of which the structural units in the molecule are changed. For example, products according to the invention which comprise one or more copolymers which contain structural units of the formula XI
—[CH₂—CHCOOH]ₘ—[CH₂—C(CH₃)C(O)—Y—SO₃H]ₚ— (XI),
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred, are likewise a preferred embodiment of the present invention, just as preference is also given to products which are characterized in that they comprise one or more copolymers which contain structural units of the formula XII
—[CH₂—C(CH₃)COOH]ₘ[CH₂—C(CH₃)C(O)—Y—SO₃H]ₚ— (XII),
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In place of acrylic acid and/or methacrylic acid, or in addition thereto, it is also possible to use maleic acid as particularly preferred monomer from group i). This gives products preferred according to the invention which are characterized in that they comprise one or more copolymers which contain structural units of the formula XIII
—[HOOCCH—CHCOOH]ₘ[CH₂—CHC(O)—Y—SO₃H]ₚ— (XIII),
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred, and gives products which are characterized in that they comprise one or more copolymers which contain structural units of the formula XIV
—[HOOCCH—CHCOOH CH₂—C(CH₃)C(O)O—Y—SO₃H ₚ— (XIV),
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In summary, dishwasher detergents or dishwasher detergent assistants according to the invention are preferred which comprise, as ingredient b), one or more copolymers which contain structural units of the formulae IX and/or X and/or XI and/or XII and/or XIII and/or XIV
—[CH₂—CHCOOH]ₘ—[CH₂—CHC(O)—Y—SO₃H]ₚ— (IX)
—[CH₂—C(CH₃)COOH]ₘ[CH₂-CHC(O)—Y—SO₃H]ₚ— (X)
—[CHCOOH]ₘ—[CH₂—C(CH₃)C(O)—Y—SO₃H]ₚ— (XI)
—[CH₂—C(CH₃)COOH]ₘ—[CH₂—C(CH₃)C(O)—Y—SO₃H]ₚ— (XI)
—[HOOCCH—CHCOOH]ₘ—CH₂CHC(O)—Y—SO₃H]ₚ— (XIII)
—[HOOCC H—CHCOOH]ₘ—[CH₂—C(CH₃)C(O)O—Y—SO₃H]ₚ— (XIV)
in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In the polymers, all or some of the sulfonic acid groups can be present in neutralized form, i.e. the acidic hydrogen atom of the sulfonic acid group in some or all sulfonic acid groups can be replaced with metal ions, preferably alkali metal ions and in particular with sodium ions. Corresponding products which are characterized in that the sulfonic acid groups in the copolymer are in partially or completely neutralized form are preferred in accordance with the invention.

The monomer distribution of the copolymers used in the products according to the invention is, in the case of copolymers which comprise only monomers from groups i) and ii), preferably in each case 5 to 95% by weight of i) or ii), particularly preferably 50 to 90% by weight of monomer from group i) and 10 to 50% by weight of monomer from group ii), in each case based on the polymer.

In the case of terpolymers, particular preference is given to those which comprise 20 to 85% by weight of monomer from group i), 10 to 60% by weight of monomer from group ii), and 5 to 30% by weight of monomer from group iii).

The molar mass of the polymers used in the products according to the invention can be varied in order to match the properties of the polymers to the desired intended use. Preferred dishwasher detergents are characterized in that the copolymers have molar masses of from 2000 to 200 000 gmol⁻¹, preferably from 4000 to 25 000 gmol⁻¹ and in particular from 5000 to 15 000 gmol⁻¹.

The content of one or more copolymers in the products according to the invention can vary depending on the intended use and desired product performance, preferred dishwasher detergents according to the invention being characterized in that the copolymer or copolymers is/are present in amounts of from 0.25 to 50% by weight, preferably from 0.5 to 35% by weight, particularly preferably from 0.75 to 20% by weight and in particular from 1 to 15% by weight.

As already mentioned above, in the compositions according to the invention particular preference is given both to using polyacrylates and also the above-described copolymers of unsaturated carboxylic acids, monomers containing sulfonic acid groups, and optionally further ionic or nonionogenic monomers. The polyacrylates have been described in detail above.

Particular preference is given to combinations of the above-described copolymers containing sulfonic acid groups with polyacrylates of low molar mass, for example in the range between 1000 and 4000 daltons. Such polyacrylates are commercially available under the trade name Sokalan® PA15 and Sokalan® PA25 (BASF).

Also suitable are copolymeric polycarboxylates, in particular those of acrylic acid with methacrylic acid and of acrylic acid or methacrylic acid with maleic acid. Copolymers which have been found particularly suitable are those of acrylic acid with maleic acid which contain from 50 to 90% by weight of acrylic acid and from 50 to 10% by weight of maleic acid. Their relative molecular mass, based on free acids, is generally 2000 to 100 000 g/mol, preferably 20 000 to 90 000 g/mol and in particular 30 000 to 80 000 g/mol.

The (co)polymeric polycarboxylates can either be used as powder or as aqueous solution. The content of (co)polymeric polycarboxylates in the compositions is preferably 0.5 to 20% by weight, in particular 3 to 10% by weight.

In order to improve the solubility in water, the polymers may also contain allylsulfonic acids, such as, for example, allyloxybenzenesulfonic acid and methallylsulfonic acid, as monomers.

Particular preference is also given to biodegradable polymers comprising more than two different monomer units, for example those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and sugar derivatives.

Further preferred copolymers have, as monomers, preferably acrolein and acrylic acid/acrylic acid salts or acrolein and vinyl acetate.

Further preferred builder substances which may likewise be mentioned are polymeric aminodicarboxylic acids, salts thereof or precursor substances thereof. Particular preference is given to polyaspartic acids and salts and derivatives thereof.

Further suitable builder substances are polyacetals, which may be obtained by reacting dialdehydes with polyolcarboxylic acids which have 5 to 7 carbon atoms and at least 3 hydroxyl groups. Preferred polyacetals are obtained from dialdehydes such as glyoxal, glutaraldehyde, terphthalaldehyde, and mixtures thereof and from polyolcarboxylic acids, such as gluconic acid and/or glucoheptonic acid.

Further suitable organic builder substances are dextrins, for example oligomers or polymers of carbohydrates which may be obtained by partial hydrolysis of starches. The hydrolysis can be carried out in accordance with customary processes, for example acid- or enzyme-catalyzed processes. The hydrolysis products preferably have average molar masses in the range from 400 to 500 000 g/mol. Preference is given here to a polysaccharide with a dextrose equivalent (DE) in the range from 0.5 to 40, in particular from 2 to 30, DE being a customary measure of the reducing effect of a polysaccharide compared with dextrose, with a DE of 100. It is possible to use either maltodextrins with a DE between 3 and 20 and dried glucose syrups having a DE of between 20 and 37, and also so-called yellow dextrins and white dextrins having higher molar masses in the range from 2000 to 30 000 g/mol.

The oxidized derivatives of such dextrins are their reaction products with oxidizing agents which are able to oxidize at least one alcohol function of the saccharide ring to the carboxylic acid function. A product oxidized on C₆ of the saccharide ring may be particularly advantageous.

Oxydisuccinates and other derivatives of disuccinates, preferably ethylenediaminedisuccinate, are also other suitable cobuilders. Ethylenediamine-N,N′-disuccinate (EDDS) is used preferably in the form of its sodium or magnesium salts. Further preference in this context is given to glycerol disuccinates and glycerol trisuccinates as well. Suitable use amounts in formulations containing zeolite and/or silicate are from 3 to 15% by weight.

Further organic cobuilders which can be used are, for example, acetylated hydroxycarboxylic acids and salts thereof, which may also be present in lactone form and which contain at least 4 carbon atoms and at least one hydroxyl group, and not more than two acids groups.

A further class of substance having cobuilder properties is the phosphonates. These are, in particular, hydroxyalkane- and aminoalkanephosphonates. Among the hydroxyalkanephosphonates, 1-hydroxyethane-1,1-diphosphonate (HEDP) is of particular importance as cobuilder. It is preferably used as the sodium salt, the disodium salt being neutral and the tetrasodium salt giving an alkaline (pH 9) reaction. Suitable aminoalkanephosphonates are preferably ethylenediamine-tetramethylenephosphonate (EDTMP), diethylenetriamine-pentamethylenephosphonate (DTPMP), and higher homologs thereof. They are preferably used in the form of the neutrally reacting sodium salts, e.g. as the hexasodium salt of EDTMP or as the hepta- and octasodium salt of DTPMP. The builder used in this case is from the class of phosphonates, preferably HEDP. In addition, the aminoalkanephosphonates have a marked heavy-metal-binding capacity. Accordingly, particularly when the compositions also comprise bleach, it may be preferred to use aminoalkanephosphonates, in particular DTPMP, or mixtures of said phosphonates.

Moreover, all compounds which are able to form complexes with alkaline earth metal ions may be used as cobuilders.

Within the scope of the present application, compositions according to the invention are characterized in that they comprise builders, preferably from the group of silicates, carbonates, organic cobuilders and/or phosphates, in amounts of from 0.1 to 99.5% by weight, preferably from 1 to 95% by weight, particularly preferably from 5 to 90% by weight and in particular from 10 to 80% by weight, in each case based on the composition.

Surfactants

Within the scope of the present application, preferred detergents comprise one or more surfactant(s) from the group of anionic, nonionic, cationic and/or amphoteric surfactants.

The anionic surfactants used are, for example, those of the sulfonate and sulfate type. Suitable surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. Likewise suitable are also the esters of α-sulfo fatty acids (ester sulfonates), e.g. the α-sulfonated methyl esters of hydrogenated coconut, palm kernel or tallow fatty acids.

Further suitable anionic surfactants are sulfated fatty acid glycerol esters. Fatty acid glycerol esters are understood as meaning the mono-, di- and triesters, and mixtures thereof, as are obtained in the preparation by esterification of a monoglycerol with 1 to 3 mol of fatty acid or in the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric half-esters of C₁₂-C₁₈-fatty alcohols, for example from coconut fatty alcohol, tallow fatty alcohol, lauryl, myristyl, cetyl or stearyl alcohol or of the C10-C₂₀-oxo alcohols and those half-esters of secondary alcohols of these chain lengths. Preference is also given to alk(en)yl sulfates of said chain length which contain a synthetic straight-chain alkyl radical prepared on a petrochemical basis and which have a degradation behavior analogous to that of the equivalent compounds based on fatty chemical raw materials. From a washing point of view, preference is given to the C₁₂-Cl₆-alkyl sulfates and C₁₂-C₁₅-alkyl sulfates, and C₁₄-C₁₅-alkyl sulfates. 2,3-Alkyl sulfates which can be obtained as commercial products of the Shell Oil Company under the name DAN® are also suitable anionic surfactants.

The sulfuric monoesters of straight-chain or branched C₇₋₂₁-alcohols ethoxylated with 1 to 6 mol of ethylene oxide, such as 2-methyl-branched C₉₋₁₁-alcohols having, on average, 3.5 mol of ethylene oxide (EO) or C₁₂₋₁₈-fatty alcohol with 1 to 4 EO, are also suitable. Due to their high foaming behavior, they are used in detergents only in relatively small amounts, for example in amounts of from 1 to 5% by weight.

Further suitable anionic surfactants are also the salts of alkylsulfosuccinic acid, which are also referred to as sulfosuccinates or as sulfosuccinic esters, and represent the monoesters and/or diesters of sulfosuccinic acid with alcohols, preferably fatty alcohols and in particular ethoxylated fatty alcohols. Preferred sulfosuccinates contain C₈₋₁₈-fatty alcohol radicals or mixtures of these. Particularly preferred sulfosuccinates contain a fatty alcohol radical which is derived from ethoxylatd fatty alcohols which, considered in themselves, represent nonionic surfactants (description see below). In this connection, particular preference is in turn given to sulfosuccinates whose fatty alcohol radicals are derived from ethoxylated fatty alcohols with a narrowed homologue distribution. It is likewise also possible to use alk(en)ylsuccinic acid having preferably 8 to 18 carbon atoms in the alk(en)yl chain or salts thereof.

Suitable further anionic surfactants are, in particular, soaps. Saturated fatty acid soaps, such as the salts of lauric acid, myristic acid, palmitic acid, stearic acid, hydrogenated erucic acid and behenic acid, and soap mixtures derived in particular from natural fatty acids, e.g. coconut, palm kernel or tallow fatty acids, are suitable.

The anionic surfactants including the soaps may be present in the form of their sodium, potassium or ammonium salts, and as soluble salts of organic bases, such as mono-, di- or triethanolamine. The anionic surfactants are preferably in the form of their sodium or potassium salts, in particular in the form of the sodium salts.

A further group of washing-active substances are the nonionic surfactants. The nonionic surfactants used are preferably alkoxylated, advantageously ethoxylated, in particular primary alcohols having preferably 8 to 18 carbon atoms and, on average, 1 to 12 mol of ethylene oxide (EO) per mole of alcohol in which the alcohol radical may be linear or preferably methyl-branched in the 2 position or may contain linear and methyl-branched radicals in the mixture, as are usually present in oxo alcohol radicals. In particular, however, preference is given to alcohol ethoxylates with linear radicals from alcohols of natural origin having 12 to 18 carbon atoms, e.g. from coconut alcohol, palm alcohol, tallow fatty alcohol or oleyl alcohol, and on average 2 to 8 EO per mole of alcohol. Preferred ethoxylated alcohols include, for example, C₁₂₋₁₄-alcohols with 3 EO or 4 EO, C₁₋₁₁-alcohol with 7 EO, C₁₃₋₁₅-alcohols with 3 EO, 5 EO, 7 EO or 8 EO, C₁₂₋₁₈-alcohols with 3 EO, 5 EO or 7 EO and mixtures of these, such as mixtures of C₁₂₋₁₄-alcohol with 3 EO and C₁₂₋₁₈-alcohol with 5 EO. The degrees of ethoxylation given represent statistical average values which may be an integer or a fraction for a specific product. Preferred alcohol ethoxylates have a narrowed homolog distribution (narrow range ethoxylates, NRE). In addition to these nonionic surfactants, fatty alcohols with more than 12 EO can also be used. Examples thereof are tallow fatty alcohol with 14 EO, 25 EO, 30 EO or 40 EO.

A further class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain, in particular fatty acid methyl esters.

A further class of nonionic surfactants which can advantageously be used are the alkyl polyglycosides (APGs). Alkyl polyglycosides which can be used satisfy the general formula RO(G)_{z}, in which R is a linear or branched, in particular methyl-branched in the 2 position, saturated or unsaturated, aliphatic radical having 8 to 22, preferably 12 to 18, carbon atoms, and G is the symbol which represents a glycose unit having 5 or 6 carbon atoms, preferably glucose. The degree of glycosylation z here is between 1.0 and 4.0, preferably between 1.0 and 2.0 and in particular between 1.1 and 1.4. Preference is given to using linear alkyl polyglucosides, e.g. alkyl polyglycosides which consist of a glucose radical and an n-alkyl chain.

A further class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain.

Nonionic surfactants of the amine oxide type, for example N-cocoalkyl-N,N-dimethylamine oxide and N-tallow-alkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula (XV), 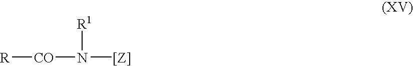
in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula (XVI), 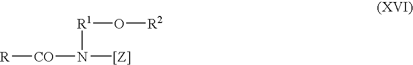
in which R is a linear or branched alkyl or alkenyl radical having 7 to 12 carbon atoms, R¹ is a linear, branched or cyclic alkyl radical or an aryl radical having 2 to 8 carbon atoms, and R² is a linear, branched or cyclic alkyl radical or an aryl radical or an oxy-alkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can then be converted into the desired polyhydroxy fatty acid amides by reaction with fatty acid methyl esters in the presence of an alkoxide as catalyst.

In the case of washing and cleaning compositions for machine dishwashing, suitable surfactants are generally all surfactants. However, preference is given for this intended use to the above-described nonionic surfactants and here primarily to low-foaming nonionic surfactants. Particular preference is given to the alkoxylated alcohols, particularly the ethoxylated and/or propoxylated alcohols. In this connection, the person skilled in the art generally understands alkoxylated alcohols as meaning the reaction products of alkylene oxide, preferably ethylene oxide, with alcohols, preferably for the scope of the present invention the longer-chain alcohols (C₁₀ to C₁₈, preferably between C₁₂ and C₁₆, such as, for example, C₁₁-, C₁₂-, C₁₃-, C₁₄-, C₁₅-, C₁₆-, C₁₇- and C₁₈-alcohols). As a rule, n moles of ethylene oxide and one mole of alcohol produce a complex mixture of addition products of a varying degree of ethoxylation, depending on the reaction conditions. A further embodiment consists in the use of mixtures of the alkylene oxides, preferably of the mixture of ethylene oxide and propylene oxide. If desired, subsequent etherification with short-chain alkyl groups, such as preferably the butyl group, may also lead to the class of substance of “capped” alcohol ethoxylates, which can likewise be used within the scope of the invention. Very particular preference within the scope of the present invention is given here to highly ethoxylated fatty alcohols or mixtures thereof with terminally capped fatty alcohol ethoxylates.

Within the scope of the present invention, low-foaming nonionic surfactants which have alternate ethylene oxide and alkylene oxide units have proven to be particularly preferred as nonionic surfactants. Among these, preference is in turn given to surfactants with EO-AO-EO-AO blocks, where in each case one to ten EO or AO groups are bonded to one another before a block from the respective other groups follows. In this connection preference is given to dishwasher detergents according to the invention which comprise, as nonionic surfactant(s), surfactants of the general formula XVII 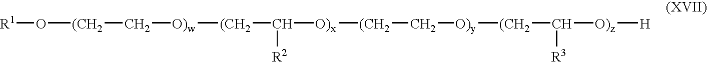
in which R¹ is a straight-chain or branched, saturated or mono- or polyunsaturated C₆₋₂₄-alkyl or -alkenyl radical; each group R² or R³, independently of the other, is chosen from —CH₃; —CH₂CH₃, —CH₂CH₂—CH₃, —CH(CH₃)₂ and the indices w, x, y, z, independently of one another, are integers from 1 to 6.

The preferred nonionic surfactants of the formula XVII can be prepared by known methods from the corresponding alcohols R¹—OH and ethylene oxide or alkylene oxide. The radical R¹ in the above formula XVII can vary depending on the origin of the alcohol. If natural sources are used, the radical R¹ has an even number of carbon atoms and is usually unbranched, preference being given to the linear radicals from alcohols of natural origin having 12 to 18 carbon atoms, e.g. from coconut alcohol, palm alcohol, tallow fatty alcohol or oleyl alcohol. Alcohols accessible from synthetic sources are, for example, the Guerbet alcohols or radicals methyl-branched in the 2 position, or linear and methyl-branched radicals in a mixture, as are customarily present in oxo alcohol radicals. Irrespective of the type of alcohol used for the preparation of the nonionic surfactants present according to the invention in the compositions, preference is given to dishwasher detergents according to the invention in which R¹ in the formula XVII is an alkyl radical having 6 to 24, preferably 8 to 20, particularly preferably 9 to 15 and especially 9 to 11, carbon atoms.

Besides propylene oxide, a suitable alkylene oxide unit which is present alternately to the ethylene oxide unit in the preferred nonionic surfactants is, in particular, butylene oxide. However, further alkylene oxides in which R² and R³ are chosen independently of one another from —CH₂CH₂—CH₃ and —CH(CH₃)₂ are also suitable. Preferred dishwasher detergents are characterized in that R² and R³ are a radical —CH₃, w and x, independently of one another, are values of 3 or 4, and y and z, independently of one another, are values of 1 or 2.

In summary, for the use in the compositions according to the invention, particular preference is given to nonionic surfactants which have a C₉₋₁₅-alkyl radical having 1 to 4 ethylene oxide units, followed by 1 to 4 propylene oxide units, followed by 1 to 4 ethylene oxide units, followed by 1 to 4 propylene oxide units.

The preferred additional surfactants used are low-foaming nonionic surfactants. With particular preference, the dishwasher detergents according to the invention comprise a nonionic surfactant which has a melting point above room temperature. Consequently, preferred compositions are characterized in that they comprise nonionic surfactant(s) with a melting point of 20° C., preferably above 25° C., particularly preferably between 25 and 60° C. and in particular between 26.6 and 43.3° C.

Suitable nonionic surfactants in addition to the nonionic surfactants present according to the invention in the compositions which have melting or softening points in the stated temperature range are, for example, low-foaming nonionic surfactants which may be solid or of high viscosity at room temperature. If nonionic surfactants are used which are of high viscosity at room temperature, then it is preferred for these to have a viscosity above 20 Pas, preferably above 35 Pas and in particular above 40 Pas. Nonionic surfactants which have a wax-like consistency at room temperature are also preferred.

Nonionic surfactants to be used which are solid at room temperature preferably originate from the groups of alkoxylated nonionic surfactants, in particular the ethoxylated primary alcohols and mixtures of these surfactants with structurally more complicated surfactants, such as polyoxypropylene/polyoxyethylene/polyoxypropylene (PO/EO/PO) surfactants. Such (PO/EO/PO) nonionic surfactants are, moreover, characterized by good foam control.

In a preferred embodiment of the present invention, the nonionic surfactant with a melting point above room temperature is an ethoxylated nonionic surfactant which arises from the reaction of a monohydroxyalkanol or alkylphenol having 6 to 20 carbon atoms with preferably at least 12 mol, particularly preferably at least 15 mol, in particular at least 20 mol, of ethylene oxide per mole of alcohol or alkylphenol.

A particularly preferred nonionic surfactant to be used which is solid at room temperature is obtained from a straight-chain fatty alcohol having 16 to 20 carbon atoms (C₁₆₋₂₀-alcohol), preferably a C₁₈-alcohol and at least 12 mol, preferably at least 15 mol and in particular at least 20 mol of ethylene oxide. Among these, particular preference is given to the so-called “narrow range ethoxylates” (see above).

Accordingly, particularly preferred compositions according to the invention comprise ethoxylated nonionic surfactant(s) which has/have been obtained from C₆₋₂₀-monohydroxyalkanols or C₆₋₂₀-alkylphenols or C₁₆₋₂₀-fatty alcohols and more than 12 mol, preferably more than 15 mol and in particular more than 20 mol, of ethylene oxide per mole of alcohol.

The nonionic surfactant preferably additionally has propylene oxide units in the molecule. Preferably, such PO units constitute up to 25% by weight, particularly preferably up to 20% by weight and in particular up to 15% by weight of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules here constitutes preferably more than 30% by weight, particularly preferably more than 50% by weight and in particular more than 70% by weight, of the total molar mass of such nonionic surfactants. Preferred dishwasher detergents are characterized in that they comprise ethoxylated and propoxylated nonionic surfactants in which the propylene oxide units in the molecule constitute up to 25% by weight, preferably up to 20% by weight and in particular up to 15% by weight, of the total molar mass of the nonionic surfactant.

Further nonionic surfactants with melting points above room temperature to be used particularly preferably comprise 40 to 70% of a polyoxypropylene/polyoxyethylene/polyoxypropylene block polymer blend which contains 75% by weight of an inverse block copolymer of polyoxyethylene and polyoxypropylene with 17 mol of ethylene oxide and 44 mol of propylene oxide and which further contains 25% by weight of a block copolymer of polyoxyethylene and polyoxypropylene, initiated with trimethylolpropane and comprising 24 mol of ethylene oxide and 99 mol of propylene oxide per mol of trimethylolpropane.

Nonionic surfactants which can be used with particular preference are available, for example, under the name Poly Tergent SLF-18 from Olin Chemicals.

A further preferred dishwasher detergent according to the invention comprises nonionic surfactants of the formula
R¹O[CH₂CH (CH₃)O]ₓCH₂CH₂O]_{y}[CH₂CH(OH)R²]
in which R¹ is a linear or branched aliphatic hydrocarbon radical having 4 to 18 carbon atoms or mixtures thereof, R² is a linear or branched hydrocarbon radical having 2 to 26 carbon atoms or mixtures thereof, and x is values between 0.5 and 1.5 and y is a value of at least 15.

Further nonionic surfactants which can preferably be used are the terminally capped poly(oxyalkylated) nonionic surfactants of the formula
R²O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is values between 1 and 30, k and j are values between 1 and 12, preferably between 1 and 5. If the value x is ≧2, each R³ in the above formula may be different. R¹ and R² are preferably linear or branched, saturated or unsaturated, aliphatic or aromatic hydrocarbon radicals having 6 to 22 carbon atoms, particular preference being given to radicals with 8 to 18 carbon atoms. For the radical R³, H, —CH₃ or —CH₂CH₃ are particularly preferred. Particularly preferred values for x are in the range from 1 to 20, in particular from 6 to 15.

As described above, each R³ in the above formula may be different if x is ≧2. As a result of this, the alkylene oxide unit in the square brackets may be varied. If, for example, x is 3, the radical R³ may be chosen in order to form ethylene oxide (R³═H) or propylene oxide (R³═CH₃) units, which can be arranged in any order, for example (EO)(PO)(EO), (EO)(EO)(PO), (EO)(EO)(EO), (PO)(EO)(PO), (PO) (PO) (EO) and (PO) (PO) (PO). The value 3 for x has been chosen here by way of example and it is entirely possible for it to be larger, the scope for variation increasing with increasing values of x and embracing, for example, a large number of (EO) groups, combined with a small number of (PO) groups, or vice versa.

Particularly preferred terminally capped poly(oxyalkylated) alcohols of the above formula have values of k=1 and j=1, so that the above formula is simplified to
R¹O[CH₂CH(R³)O]ₓCH₂CH(OH)CH₂OR².

In the last-mentioned formula, R¹, R² and R³ are as defined above and x represents numbers from 1 to 30, preferably from 1 to 20 and in particular from 6 to 18. Particular preference is given to surfactants in which the radicals R¹ and R² have 9 to 14 carbon atoms, R³ is H and x assumes values from 6 to 15.

Summarizing the last-mentioned statements, preference is given to dishwasher detergents according to the invention which comprise terminally capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is a methyl, ethyl, n-propyl, isopropyl, n-butyl, 2-butyl or 2-methyl-2-butyl radical, x is values between 1 and 30, k and j are values between 1 and 12, preferably between 1 and 5, particular preference being given to surfactants of the type
R¹O[CH₂CH(R³)O]ₓCH₂CH(OH)CH₂OR²
in which x is numbers from 1 to 30, preferably from 1 to 20 and in particular from 6 to 18.

In conjunction with said surfactants it is also possible to use anionic, cationic and/or amphoteric surfactants, the latter, due to their foaming behavior in dishwasher detergents, being only of minor importance and in most cases only used in amounts below 10% by weight, in most cases even below 5% by weight, for example from 0.01 to 2.5% by weight, in each case based on the composition. The compositions according to the invention may thus also comprise anionic, cationic, and/or amphoteric surfactants as surfactant component.

Within the scope of the present invention, it is preferred for the dishwasher detergents or dishwasher detergent assistants to comprise surfactant(s), preferably nonionic surfactant(s), in amounts of from 0.5 to 10% by weight, preferably from 0.75 to 7.5% by weight and in particular from 1.0 to 5% by weight, in each case based on the total composition.

Bleaches

Bleaches and bleach activators are important constituents of detergents and cleaners and a preferred dishwasher detergent or dishwasher detergent assistant can, within the scope of the present invention, comprise one or more substances from the groups given. Among the compounds used as bleaches which produces H₂O₂ in water, sodium percarbonate is of particular importance. Further bleaches which can be used are, for example, sodium perborate tetrahydrate and sodium perborate monohydrate, peroxypyrophosphates, citrate perhydrates, and H₂O₂-producing peracidic salts or peracids, such as perbenzoates, peroxophthalates, diperazelaic acid, phthaloimino peracid or diperdodecanedioic acid.

“Sodium percarbonate” is a term used unspecifically for sodium carbonate peroxohydrates, which, strictly speaking, are not “percarbonates” (i.e. salts of percarbonic acid) but hydrogen peroxide adducts with sodium carbonate. The commercial product has the average composition 2Na₂CO₃.3H₂O₂ and is thus not a peroxycarbonate. Sodium percarbonate forms a white, water-soluble powder of density 2.14 gcm⁻³, which readily breaks down into sodium carbonate and oxygen which has a bleaching and/or oxidizing effect.

Dishwasher detergents may also comprise bleaches from the group of organic bleaches. Typical organic bleaches which may be used as ingredients within the scope of the present invention are the diacyl peroxides, such as, for example, dibenzoyl peroxide. Further typical organic bleaches are the peroxy acids, particular examples being the alkyl peroxy acids and the aryl peroxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamidoperoxycaproic acid, N-nonenylamidoperadipic acid and N-nonenylamido-persuccinate, and (c) aliphatic and araliphatic peroxy-dicarboxylic acids, such as 1,2-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid) may be used.

According to the present invention, bleaches which may be used for machine dishwashing are also substances which release chlorine or bromine. Among suitable chlorine- or bromine-releasing materials, examples include heterocyclic N-bromoamides and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Within the scope of the present invention, advantageous compositions comprise one or more bleaches, preferably from the group of oxygen or halogen bleaches, in particular chlorine bleaches, particularly preferably sodium percarbonate and/or sodium perborate monohydrate, in amounts of from 0.5 to 40% by weight, preferably from 1 to 30% by weight, particularly preferably from 2.5 to 25% by weight and in particular from 5 to 20% by weight, in each case based on the total composition.

Bleach Activators

In order to achieve an improved bleaching effect when washing at temperatures of 60° C. and below, within the scope of the present invention, detergents can comprise bleach activators. Bleach activators which may be used are compounds which, under perhydrolysis conditions, produce aliphatic peroxocarboxylic acids having preferably 1 to 10 carbon atoms, in particular 2 to 4 carbon atoms, and/or optionally substituted perbenzoic acid. Substances which carry O- and N-acyl groups of said number of carbon atoms and/or optionally substituted benzoyl groups are suitable. Preference is given to polyacylated alkylenediamines, in particular tetraacetylethylenediamine (TAED), acylated triazine. derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

In addition to the conventional bleach activators, or instead of them, so-called bleach catalysts can also be incorporated according to the present invention into the detergents. These substances are bleach-boosting transition metal salts or transition metal complexes, such as, for example, Mn—, Fe—, Co—, Ru—or Mo-salen complexes or -carbonyl complexes. Mn, Fe, Co, Ru, Mo, Ti, V and Cu complexes with N-containing tripod ligands, and also Co—, Fe—, Cu— and Ru-ammine complexes can also be used as bleach catalysts.

According to the invention, preference is given to compositions which comprise one or more substances from the group of bleach activators, in particular from the groups of polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS) and n-methylmorpholiniumacetonitrile methylsulfate (MMA), in amounts of from 0.1 to 20% by weight, preferably from 0.5 to 15% by weight and in particular from 1 to 10% by weight, in each case based on the total composition.

Bleach activators which are preferred within the scope of the present invention further include the “nitrile quats”, cationic nitrites of the formula (XVIII), 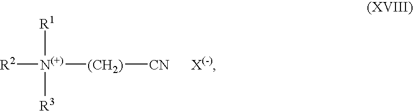
in which R¹ is —H, —CH₃, a C₂₋₂₄-alkyl or -alkenyl radical, a substituted C₂₋₂₄-alkyl or -alkenyl radical with at least one substituent from the group —Cl, —Br, —OH, —NH₂, —CN, an alkyl- or alkenylaryl radical with a C₁₋₂₄-alkyl group, or is a substituted alkyl- or alkenylaryl radical with a C₁₋₂₄-alkyl group and at least one further substituent on the aromatic ring, R² and R³, independently of one another, are chosen from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH where n=1, 2, 3, 4, 5 or 6 and X is an anion.

The general formula (XVIII) covers a large number of cationic nitriles which can be used within the scope of the present invention. With particular advantage, the detergent and cleaner shaped bodies according to the invention comprise cationic nitriles in which R¹ is methyl, ethyl, propyl, isopropyl or an n-butyl, n-hexyl, n-octyl, n-decyl, n-dodecyl, n-tetradecyl, n-hexadecyl or n-octadecyl radical. R² and R³ are preferably chosen from methyl, ethyl, propyl, isopropyl and hydroxyethyl, where one or both of the radicals may advantageously also be a cyanomethylene radical.

For reasons of easier synthesis, preference is given to compounds in which the radicals R¹ to R³ are identical, for example (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻ or (HO—CH₂—CH₂)₃N⁽⁺⁾CH₂—CN X⁻, where X⁻ is preferably an anion which is chosen from the group consisting of chloride, bromide, iodide, hydrogensulfate, methosulfate, p-toluenesulfonate (tosylate) or xylenesulfonate.

Dishwasher detergents or detergent assistants preferred within the scope of the present invention are characterized in that they comprise the cationic nitrile of the formula (XVIII) in amounts of from 0.1 to 20% by weight, preferably from 0.25 to 15% by weight and in particular from 0.5 to 10% by weight, in each case based on the total weight of the composition.

Enzymes

Suitable enzymes are, in particular, those from the classes of hydrolases, such as the proteases, esterases, lipases and lipolytic enzymes, amylases, cellulases or other glycosyl hydrolases, and mixtures of said enzymes. In the washing, all of these hydrolases contribute to the removal of stains, such as proteinaceous, fatty or starchy stains and graying. Cellulases and other glycosylhydrolases may, furthermore, contribute to the retention of color and to an increase in the softness of the textile by removing pilling and microfibrils. For the bleaching and for inhibiting color transfer it is also possible to use oxidoreductases. Especially suitable enzymatic active ingredients are those obtained from bacterial strains or fungi such as Bacillus subtilis, Bacillus licheniformis, Streptomyceus griseus, Coprinus cinereus and Humicola insolens, and also from genetically modified variants thereof. Preference is given to using proteases of the subtilisin type and in particular proteases which are obtained from Bacillus lentus. Of particular interest in this context are enzyme mixtures, examples being those of protease and amylase or protease and lipase or lipolytic enzymes, or protease and cellulase or of cellulase and lipase or lipolytic enzymes or protease, amylase and lipase or lipolytic enzymes, or protease, lipase or lipolytic enzymes and cellulase, but in particular protease and/or lipase-containing mixtures or mixtures containing lipolytic enzymes. Examples of such lipolytic enzymes are the known cutinases.

Peroxidases or oxidases have also proven suitable in some cases. Suitable amylases include, in particular, α-amylases, isoamylases, pullulanases, and pectinases. The cellulases used are preferably cellobiohydrolases, endoglucanases and endoglucosidases, which are also cellobiases, and mixtures thereof. Because different types of cellulase differ in their CMCase and Avicelase acctivities, specific mixtures of the cellulases may be used to establish the desired activities.

The enzymes can be adsorbed on carrier substances or embedded in coating substances in order to protect them against premature decomposition. Preferred compositions according to the invention comprise enzymes, preferably in the form of liquid and/or solid enzyme preparations, in amounts of from 0.1 to 10% by weight, preferably from 0.5 to 8% by weight and in particular from 1 to 5% by weight, in each case based on the total composition.

Dyes

In order to improve the esthetic impression of the dishwasher detergents or dishwasher detergent assistants, they may be colored with suitable dyes. Dyes which are preferred within the scope of the invention, the selection of which presents no difficulty whatsoever to the person skilled in the art, have a high storage stability and insensitivity toward the other ingredients of the compositions and toward light and have no pronounced substantivity toward the ware, so as not to stain them.

Preference for use in the dishwasher detergents or dishwasher detergent assistants according to the invention is given to all colorants which can be oxidatively destroyed in the cleaning process, and to mixtures thereof with suitable blue dyes, so-called bluing agents. It has proven advantageous to use colorants which are soluble in water or, at room temperature, in liquid organic substances. Examples of suitable colorants are anionic colorants, e.g. anionic nitroso dyes. One possible colorant is, for example, naphthol green (Colour Index (CI). Part 1: Acid Green 1; Part 2: 10020), which is available as a commercial product, for example as Basacid® Green 970 from BASF, Ludwigshafen, Germany, and mixtures thereof with suitable blue dyes. Further suitable colorants are Pigmosol® Blue 6900 (CI 74160), Pigmosol® Green 8730 (CI 74260), Basonyl Red 545 FL (CI 45170), Sandolan® Rhodamin EB400 (CI 45100), Basacid® Yellow 094 (CI 47005), Sicovit® Patent Blue 85 E 131 (CI 42051), Acid Blue 183 (CAS 12217-22-0, CI Acid Blue 183), Pigment Blue 15 (CI 74160), Supranol® Blue GLW (CAS 12219-32-8, CI Acid Blue 221)), Nylosan Yellow N-7GL SGR (CAS 61814-57-1, CI Acid Yellow 218) and/or Sandolan® Blue (CI Acid Blue 182, CAS 12219-26-0).

Fragrances

Fragrances are added to the compositions within the scope of the present invention in order to improve the esthetic impression of the compositions and to provide the consumer with not only the performance of the composition, but also a visually and sensorily “typical and unmistakable” composition.

Perfume oils and fragrances which can be used within the scope of the present invention are individual odorant compounds, e.g. the synthetic compositions of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexyl propionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethol, citronellol, eugenol, geraniol, linalool, phenylethyl alcohol and terpineol; the hydrocarbons include primarily the terpenes such as limonene and pinene.

Preference, however, is given to mixtures of different odorants which together produce a pleasing fragrance note. Such perfume oils may also comprise natural odorant mixtures, as are available from plant sources, examples being pine oil, citrus oil, jasmine oil, patchouli oil, rose oil or ylang ylang oil. Likewise suitable are clary sage oil, camomile oil, oil of cloves, balm oil, mint oil, cinnamon leaf oil, lime blossom oil, juniper berry oil, vetiver oil, olibanum oil, galbanum oil and labdanum oil, and also orange blossom oil, neroli oil, orange peel oil and sandalwood oil.

Corrosion Protectants

Dishwasher detergents can comprise corrosion inhibitors to protect the ware or the machine, with silver protectants being of particular importance in the field of machine dishwashing. The known substances of the prior art may be used. In general, it is possible to use, in particular, silver protectants chosen from the group of triazoles, of benzotriazoles, of bisbenzotriazoles, of aminotriazoles, of alkylaminotriazoles and of transition metal salts or complexes. Particular preference is given to the use of benzotriazole and/or alkylaminotriazole. Frequently encountered in cleaning formulations, furthermore, are agents containing active chlorine, which may significantly reduce corrosion of the silver surface. In chlorine-free cleaners, use is made in particular of oxygen- and nitrogen-containing organic redox-active compounds, such as di- and trihydric phenols, e.g. hydroquinone, pyrocatechol, hydroxyhydroquinone, gallic acid, phloroglucinol, pyrogallol, and derivatives of these classes of compounds. Inorganic compounds in the form of salts and complexes, such as salts of the metals Mn, Ti, Zr, Hf, V, Co and Ce, are also often used. Preference is given here to. the transition metal salts which are chosen from the group of manganese and/or cobalt salts and/or complexes, particularly preferably cobalt(ammine) complexes, cobalt(acetato) complexes, cobalt(carbonyl) complexes, the chlorides of cobalt or of manganese and manganese sulfate, and the manganese complexes [Me-TACN)Mn^{IV}(m-0)₃Mn^{IV}(Me—TACN)]²⁺(PF₆⁻)₂, Me—Me—TACN)Mn^{IV}(m-0)₃Mn^{IV}(Me—Me—TACN)]²⁺(PF₆⁻)₂, [Me—TACN)Mn^{III}(m-0) (m-OAc)₂Mn^{III}(Me—TACN)]²⁺(PF₆⁻)₂ and [Me—Me—TACN)Mn^{III} (m-0) (m-OAc)₂Mn^{III} (Me—Me—TACN)²⁺(PF₆⁻)₂, where Me—TACN is 1,4,7-trimethyl-1,4,7-triazacyclononane and Me—Me—TACN is 1,2,4,7-tetramethyl-1,4,7-triazacyclononane. Zinc compounds may likewise be used to prevent corrosion on the ware.

Within the scope of the present invention, preference is given to dishwasher detergents or dishwasher detergent assistants which additionally comprise at least one silver protectant chosen from the group of triazoles, benzotriazoles, bisbenzotriazoles, aminotriazoles, alkylaminotriazoles, preferably benzotriazole and/or alkylaminotriazole, in amounts of from 0.001 to 1% by weight, preferably from 0.01 to 0.5% by weight and in particular from 0.05 to 0.25% by weight, in each case based on the total composition.

The present application further provides the use of a dishwasher detergent or dishwasher detergent assistant according to the invention for reducing glass corrosion during machine dishwashing.

### EXAMPLES

Unsoiled glasses were washed in a continuously operated dishwasher using a standard commercial dishwasher detergent at a water hardness of 0-1° German hardness.

In the comparative example VI, for each wash cycle only 24.5 g of a standard commercial dishwasher detergent were dosed in. In comparative examples V2 and V3, 250 mg of zinc acetate and 400 mg of the crystalline sheet-like silicate Na-SKS-6 (6-Na₂Si₂O₅) respectively were dosed in at the same time as the 24.5 g of the standard commercial dishwasher detergent. In the example El according to the invention finally apart from the dishwasher detergent 250 mg of zinc acetate and 400 mg of Na—SKS-6 were additionally dosed in. The wash operation was repeated 50 times under the conditions described above. The overall appearance of the ware was assessed by reference to the evaluation scale given below.

The results are given in the table below:

| | V1 | V2 | V3 | E1 |
|---|---|---|---|---|
| Soda lime glass | T 2.5 | T 1.5 | T 1.5 | T 0 |
| Potash crystal | T 3 | T 2 | T 2.5 | T 0.5 |

Evaluation scale: T0 = no clouding to T4 = severe clouding

The table shows that the dishwasher detergent according to the invention, which contains the combination of a zinc salt and a crystalline sheet-like silicate, has significantly better glass corrosion properties under the given conditions than dishwashing detergents which only contain zinc salt or only contain silicate. The corrosion-inhibiting effect of the active ingredient combination of zinc salt and silicate is significantly above the total effects observed for the individual substances.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A dishwasher detergent or dishwasher detergent assistant composition, comprising at least one zinc salt and 0.1 to 20% by weight of crystalline sheet-like silicate(s) of the general formula (Ia)
NaMSiₓO₂ₓ₊₁ y.H₂O (Ia),
in which M is sodium or hydrogen, x is a number from 1.9 to 22, and y is a number from 0 to 33, wherein the zinc salt(s) and the crystalline sheet-like silicate(s) are present in a weight ratio of 3:1 to 1:10.

2. The composition of claim 1, comprising at least one inorganic zinc salt.

3. The composition of claim 2, comprising at least one soluble inorganic zinc salt.

4. The composition of claim 3, comprising one or more salts selected from the group consisting of zinc bromide, zinc chloride, zinc iodide, zinc nitrate, and zinc sulfate.

5. The composition of claim 1, comprising at least one organic zinc salt.

6. The composition of claim 5, comprising at least one soluble organic zinc salt.

7. The composition of claim 6, comprising at least one soluble zinc salts of a monomeric or polymeric organic acid.

8. The composition of claim 7, comprising one or more salts selected from the group consisting of zinc acetate, zinc acetylacetonate, zinc benzoate, zinc formate, zinc lactate, zinc gluconate, zinc ricinoleate, zinc abietate, zinc valerate, and zinc p-toluenesulfonate.

9. The composition of claim 1, comprising 0.1 to 10% by weight of the at least one zinc salt.

10. The composition of claim 9, comprising 0.2 to 7% by weight of the at least one zinc salt.

11. The composition of claim 10, comprising 0.4 to 4% by weight of the at least one zinc salt.

12. The composition of claim 1, comprising 0.2 to 15% by weight of the crystalline sheet-like silicate of the general formula (Ia).

13. The composition of claim 12, comprising 0.4 to 10% by weight of the crystalline sheet-like silicate of the general formula (Ia).

14. The composition of claim 1, wherein the zinc salt(s) and the crystalline sheet-like silicate(s) are compounded in particulate form with one or more further active or builder substances.

15. The composition of claim 14, wherein the one or more further active or builder substances are selected from the group consisting of organic mono- or polycarboxylic acids, hydroxypolycarboxylic acids, and phosphonic acids.

16. The composition of claim 1, wherein the zinc salt(s) and/or the crystalline sheet-like silicate(s) are present formulated in a polymer matrix.

17. The composition of claim 1, being in dimensionally stable form and having a penetration number of 200 to 1000 g.

18. The composition of claim 17, having a penetration number of 250 to 900 g.

19. The composition of claim 18, having a penetration number of 300 to 800 g.

20. The composition of claim 19, having a penetration number of 350 to 700 g.

21. The composition of claim 1, having a viscosity of 500 to 500,000 mPas.

22. The composition of claim 21, having a viscosity of 900 to 200,000 mPas.

23. The composition of claim 22, having a viscosity of 1300 to 100,000 mPas.

24. The dishwasher of claim 1, packaged as a portion in a water-soluble enclosure.

25. A method of cleaning dishes or flatware, comprising the steps of contacting dishes or flatware with a cleaning-effective amount of dishwasher detergent or dishwasher detergent assistant composition comprising at least one zinc salt and 0.1 to 20% by weight of crystalline sheet-like silicate(s) of the general formula (Ia)
NaMSiₓO₂ₓ₊₁ y.H₂O (Ia),
in which M is sodium or hydrogen, x is a number from 1.9 to 22, and y is a number from 0 to 33, wherein the zinc salt(s) and the crystalline sheet-like silicate(s) are present in a weight ratio of 3:1 to 1:10.

26. The composition of claim 1, wherein x is a number from 1.9 to 4.
